(19) United States
(12) Patent Application Publication
(10) Pub. No.: US 2012/0102540 A1
(43) Pub. Date: Apr. 26, 2012

(54) Single-Point-Of-Access Cyber System

(76) Inventor: Jeffry Aronson, San Antonio, TX (US)

(21) Appl. No.: 12/908,162

(22) Filed: Oct. 20, 2010

(51) Int. Cl. H04L 9/32; G06F 21/22; G06F 15/16

(52) U.S. Cl. 726/1; 709/203; 726/4; 726/3

(57) ABSTRACT

The system and system components of the present invention provides individuals with both a safe and a secure cyber environment. Within this safe and secure cyber environment each individual and each cyber device will always be properly identified for all cyber interactions with others and for all cyber interactions with the cyber devices of others. The present invention also provides individuals with privacy as required by each individual for the individual's cyber activities and cyber assets. Further, the present invention provides for environment-wide interoperable use of any cyber device, cyber programming, or cyber content.

### STATEMENT REGARDING FEDERALLY FUNDED RESEARCH AND DEVELOPMENT

The invention described in this patent application was not the subject of federally sponsored research or development.

### FIELD

The present invention pertains to a system and system components which together provide for cyber interactions among individuals and cyber devices; more particularly, the present invention pertains to a system and system components which together provide a cyber environment which provides individuals with safe, secure, private cyber interactions with properly identified others, and safe, secure, private cyber interactions with the properly identified cyber devices of others. In addition, the present invention provides individuals with the ability to selectively grant or deny others or the cyber devices of others access to all or any part of the individual's cyber activities, cyber interactions, and cyber assets. Further, the cyber environment which is provided by the present invention provides for interoperable use of cyber devices, cyber content, and cyber programming throughout the cyber environment.

### BACKGROUND

Individuals who access cyber environments have little or no assurance or expectations that the cyber environments will provide the individuals with security, privacy, or the ability to grant or deny others or the cyber devices of others access to all or any part of the individuals' cyber activities, cyber interactions, or cyber assets. In addition our cyber environments can not provide individuals with the identity of others or the identity of the cyber devices of others with whom, through use of the cyber environments, the individuals interact. Further, cyber environments do not provide for cyber environment-wide interoperable use of any cyber device, cyber programming, and cyber content.

There remains a need for a combination of system and system devices which provide a safe and secure cyber environment which provides each individual with both privacy for the individual's cyber activities and control over others' access to the individual's cyber activities, cyber interactions, and cyber assets. In addition, the need remains for a combination of system and system devices which properly identify each cyber device and each individual who use the system. Further, the need remains for a combination of system and system devices which provide cyber environment-wide interoperable use of any cyber device, cyber programming, and cyber content.

### SUMMARY

The system of the present invention includes a combination of processes, procedures, programming, system architecture, and devices which together provide individuals both a safe and a secure cyber environment. Within this safe and secure cyber environment each individual and each cyber device will always be properly identified for all cyber interactions with others and for all cyber interactions with the cyber devices of others. The present invention also provides individuals with privacy as required by each individual for the individual's cyber activities and cyber assets. The safe and secure cyber environment of the present invention further provides for environment-wide interoperable use of any cyber device, cyber programming, or cyber content which can be either configured to be used with the single-point-of-access cyber system or could be converted for use by processes and procedures which are a part of the single-point-of-access cyber system.

### BRIEF DESCRIPTION OF THE DRAWING FIGURES

A better understanding of both the system and the components of the system of the current invention may be had by referring to the drawing figures which illustrate essential architecture, components, and functions of the invention as described in the following Description of the Embodiments section.

FIG. 1. is a macro overview of the disclosed single-point-of-access cyber system.

FIG. 2. is a schematic diagram which illustrates the architecture and the architectural components of the single-point-of-access cyber system.

FIG. 3. is a schematic diagram which illustrates the interconnections and the cyber activities which occur within the architecture of the single-point-of-access cyber system.

FIG. 4. is a schematic diagram which illustrates the single-point-of-access cyber system cyber activities of the individual.

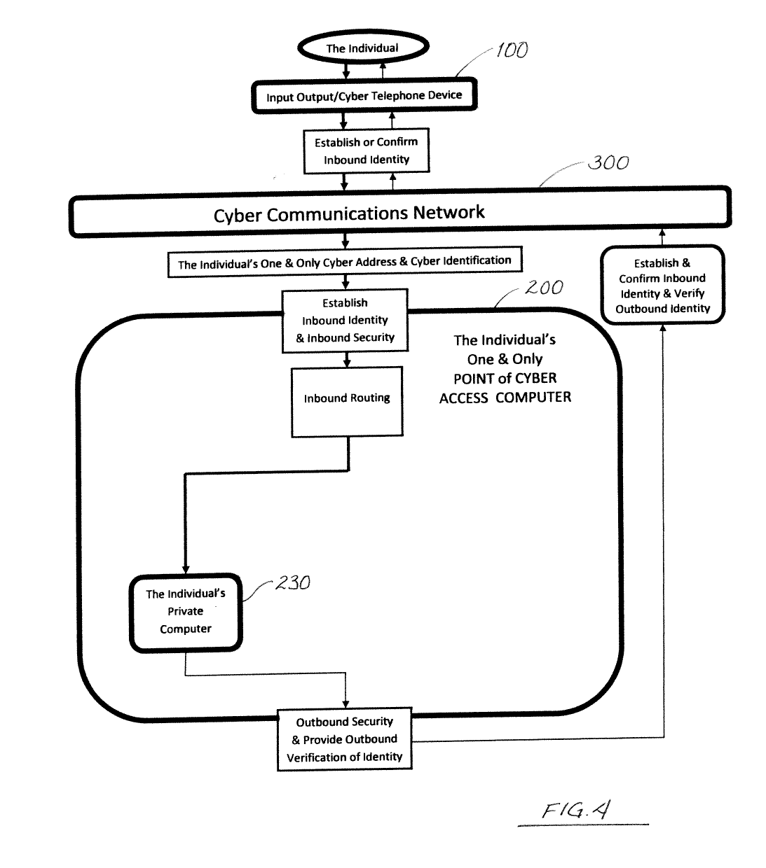

FIG. 5. is a schematic diagram which illustrates the cyber activities of the individual's device-based cyber assets.

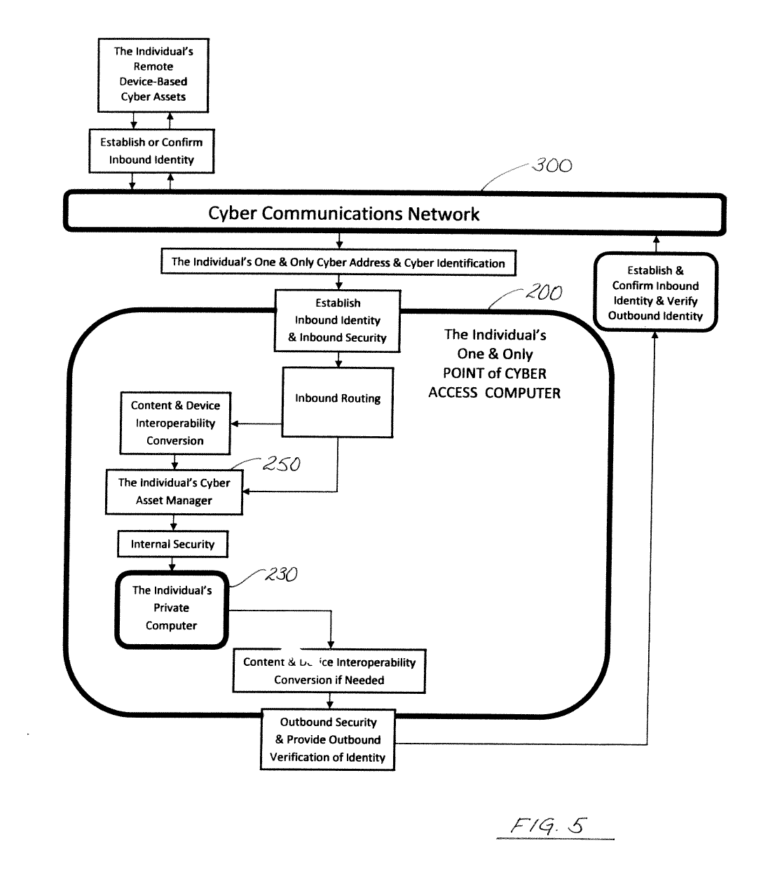

FIG. 6. is a schematic diagram which illustrates the cyber activities of the individual and the cyber activities of a remote cyber device.

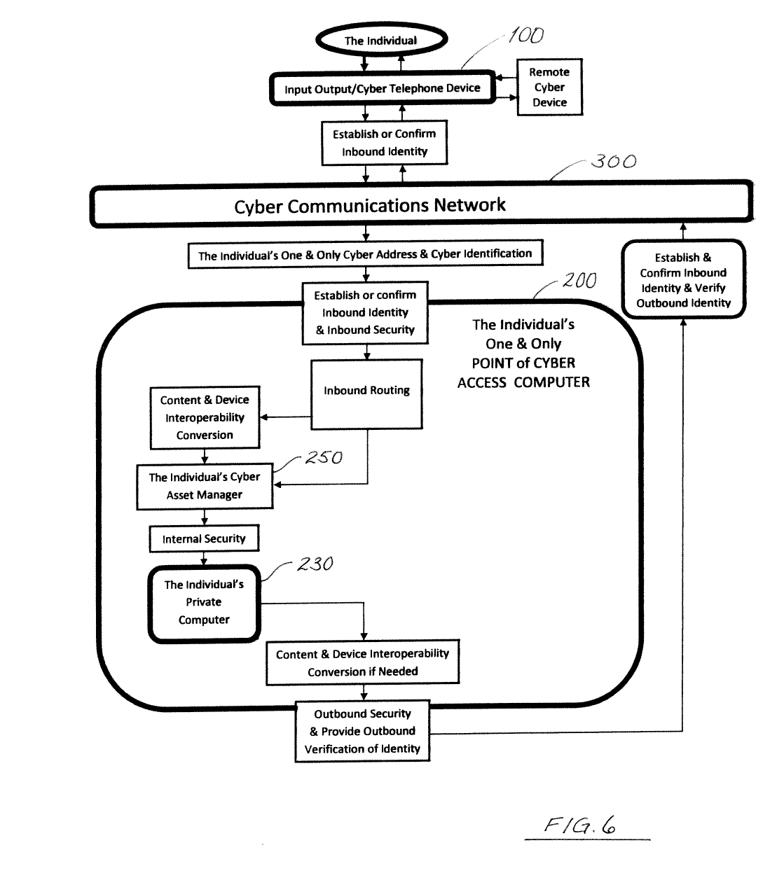

FIG. 7. is a schematic diagram which illustrates the cyber activities of the individual's device-based cyber assets, as well as the cyber activities of the individual, and a remote cyber device.

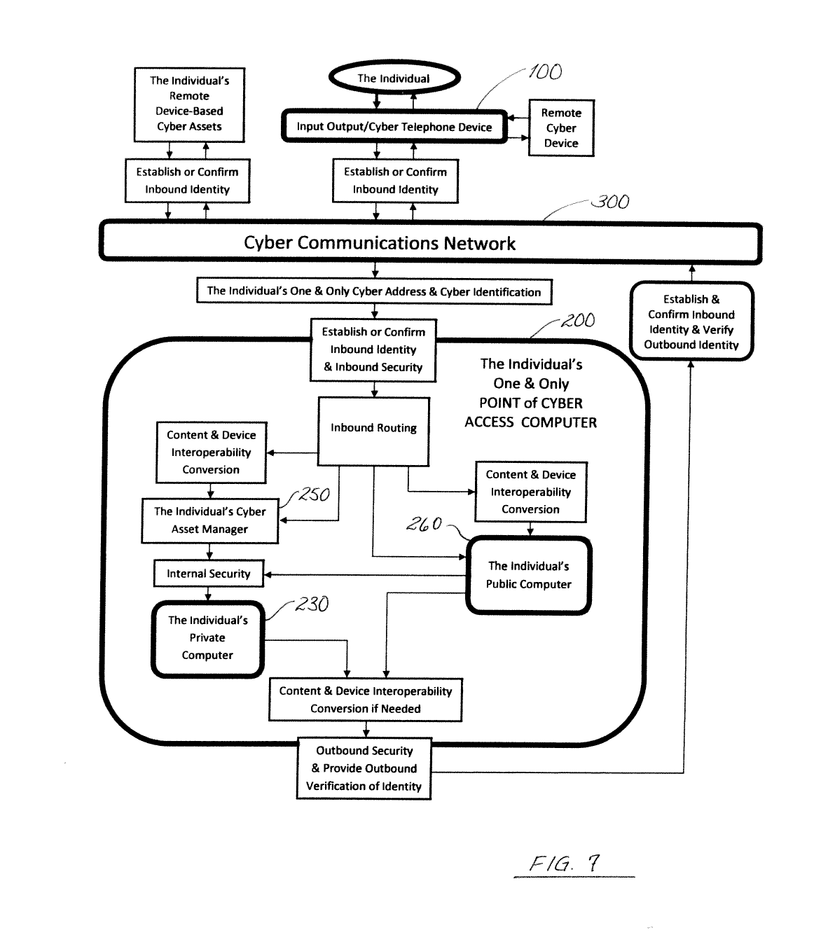

FIG. 8. is a schematic diagram which illustrates the cyber activities between others and the individual's public computer.

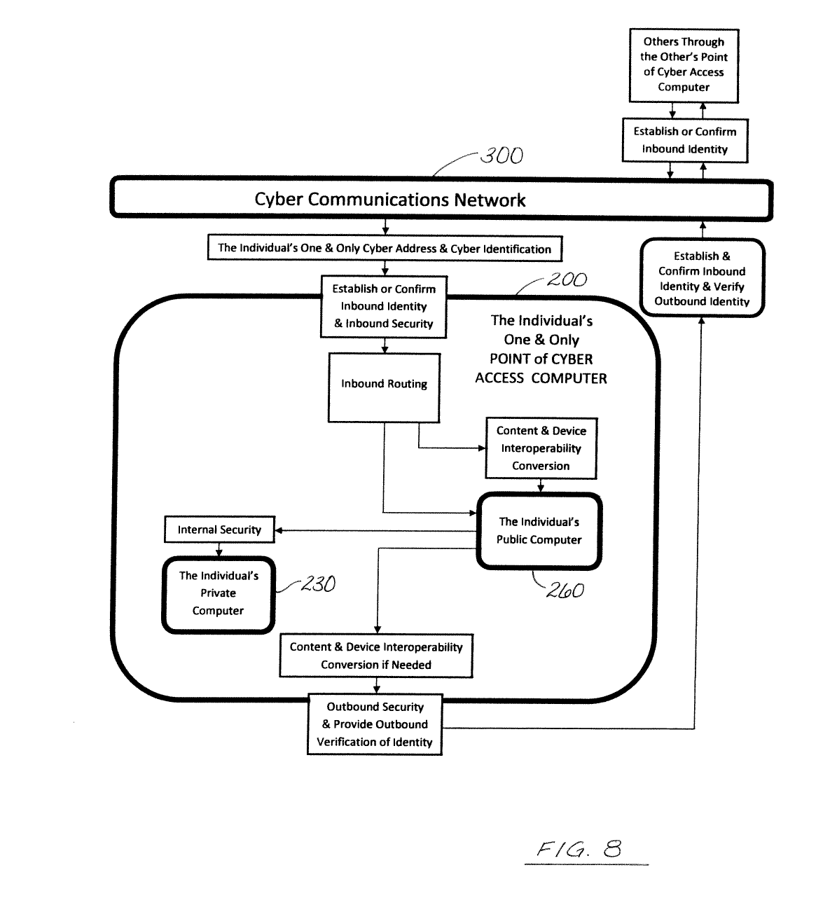

FIG. 9. is a schematic diagram which illustrates the cyber activities between others and both the individual's public computer and the individual's cyber telephone system.

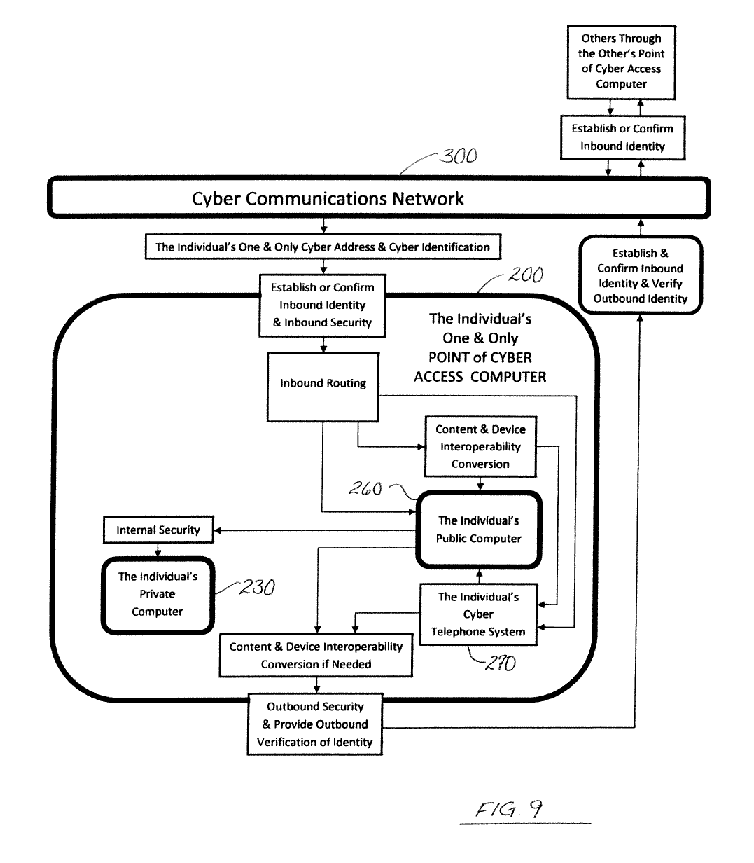

FIG. 10. is a schematic diagram which illustrates the cyber activities between others and the individual's cyber telephone system.

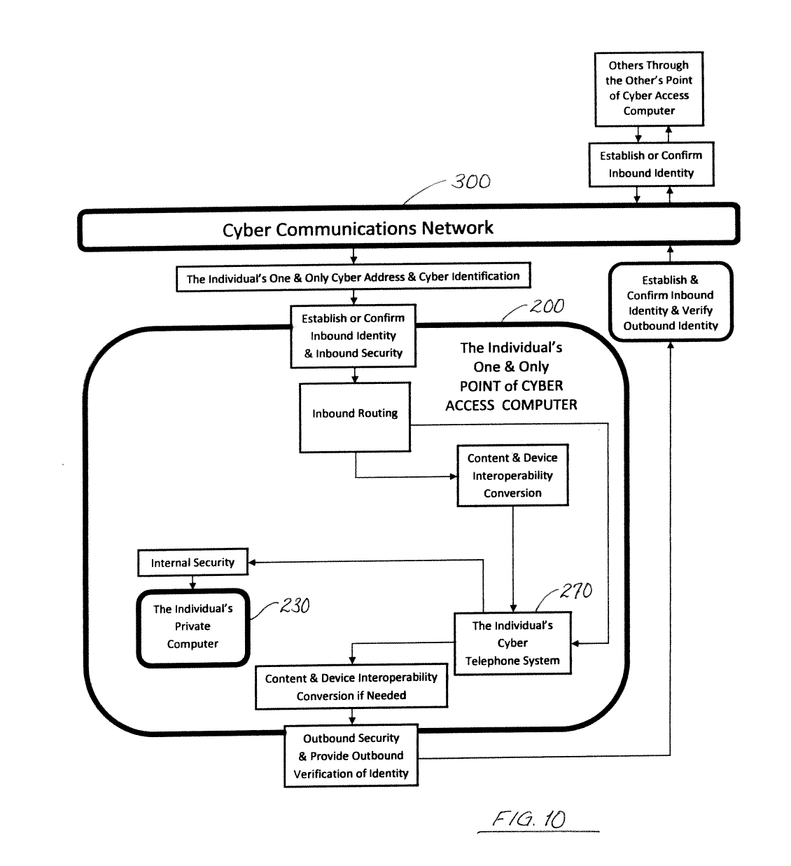

FIG. 11. is a schematic diagram which illustrates the individual's administrative-based, management-based, and operational cyber activities with the individual's device-based cyber assets.

FIG. 12. is a schematic diagram which illustrates a point of cyber access computer as well as the components, interconnections, and the cyber activities within.

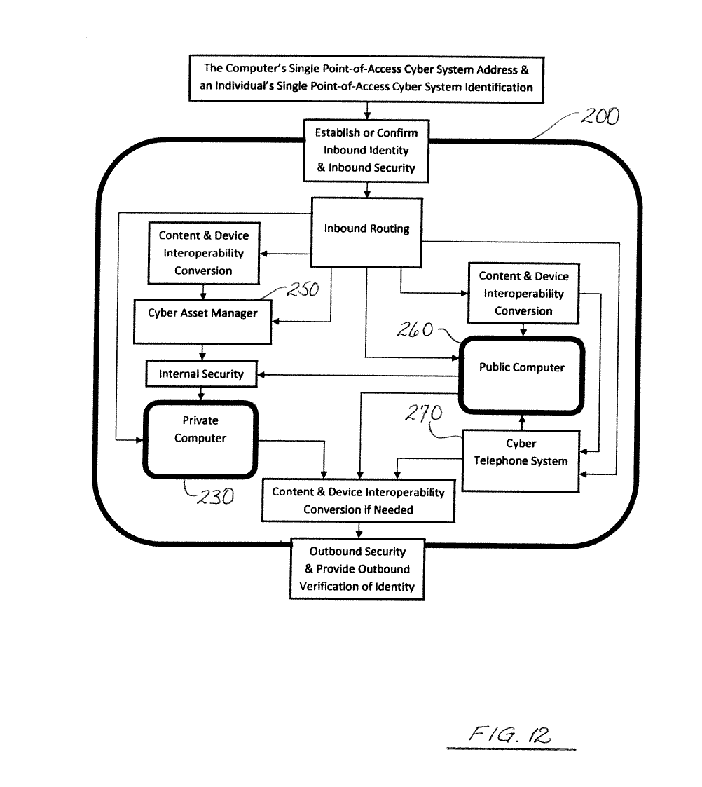

FIG. 13. is a schematic diagram which illustrates a private computer and the components, interconnections, and cyber activities within.

FIG. 14. is a schematic diagram which illustrates a public computer and the components, interconnections, and cyber activities within.

FIG. 15. is a schematic diagram which illustrates the cyber communications network of the single-point-of-access cyber system.

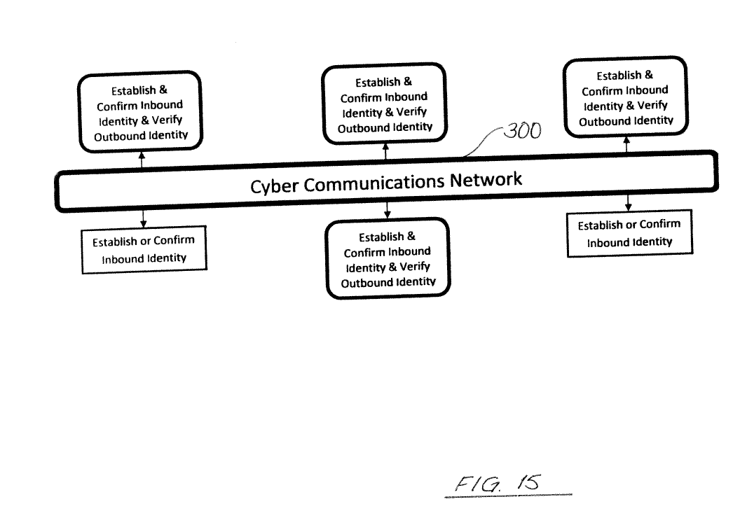

FIG. 16. is a series of illustrations of a two-screen input output device which can be configured for use in multiple forms.

FIG. 17. is an illustration of a group of virtual processes which are used for security, for interoperability conversion, and for making alterations to images.

FIG. 18. is a series of illustrations depicting cyber images in both frame format and scroll format.

### DESCRIPTION OF EMBODIMENTS

### Table of Contents

The following Description of Embodiments is organized as follows:

1. Table of contents 25

2. Key definitions 43

3. General definitions 62

4. Advantages 89

5. Short overview 96

6. Expanded overview 114

7. Single-point-of-access cyber system architecture 195

8. Universal interactive operating system 214

9. Cyber communications network 386

10. Input output device 414

11. Cyber communications network between an input output device and a point of cyber access computer 497

12. Point of cyber access computer 511

13. Cyber telephone system 588

14. Cyber communications network between a sender's point of cyber access computer and a recipient's point of cyber access computer 606

15. An individual's cyber asset manager and the individual's device-based cyber assets 618

16. Cyber communications network between an individual's cyber asset manager and the individual's remote device-based cyber assets 633

17. Examples of use of the single-point-of-access cyber system 645

### KEY DEFINITIONS

The meanings and definitions for the following list of key words and key phrases shall be used when key words and phrases from this list are used throughout this patent application.

Cyber: any activity, device, system, process, procedure, or file which uses non-biological processing for any purpose.

Cyber activities: use of any component or resource of the single point of access cyber system by an individual, or by a cyber device.

Private cyber activities: an individual's use of any component or resource of the single-point-of-access cyber system wherein all others and the cyber devices of all others are excluded from the individual's cyber activities.

Public cyber activities: an individual's use of any component or resource of the single-point-of-access cyber system which includes others or the cyber devices of others as a part the individual's cyber activities.

Cyber assets: an Individual's cyber devices or cyber files.

Device-based cyber assets: an individual's cyber devices.

File-based cyber assets: an individual's cyber files.

Cyber content: cyber files which, after processing, can be perceived by an individual through the individual's use of an input output device.

Cyber device: a physical or virtual device which uses non-biological processing to achieve any purpose or function.

Cyber resources: the cyber files and cyber devices of others. Others may make copies of their file-based cyber assets available to an individual by providing the individual with a copy of the others file based cyber asset. The copy of the other's file-based cyber asset which is made available to the individual is considered to be a cyber resource. Others may also have device-based cyber assets which are considered to be device-based cyber resources when they are shared with an individual.

Individual: any one person, living or dead, or any entity who uses the single-point-of-access cyber system.

Entity: any business, government, school, group, organization, or other entity that a single-point-of-access cyber system identification.

Identity: the single-point-of-access cyber system requires that each individual who uses the single-point-of-access cyber system and that each cyber device that is a part of the single-point-of-access cyber system have one and only one single-point-of-access cyber system identification. An individual's single-point-of-access cyber system identification or a cyber device's single-point-of-access cyber system identification can also be considered to be the individual's single-point-of-access cyber system identity or the cyber device's single-point-of-access cyber system identity.

Establish identity: the first step in the single-point-of-access cyber system identification process is when the identity of an individual or the identity of a cyber device is first established by a cyber device.

Verify identity: a cyber device which establishes the identity of an individual or a cyber device can verify the identity of the individual or the cyber device for all further cyber interactions of the individual or the cyber device.

Confirm identity: a cyber device which receives verification of the identity of an individual or of a cyber device can confirm the verified identity of the individual or the cyber device.

Properly identified: an individual or a cyber device whose identity has successfully been established, verified, or confirmed as required by single-point-of-access cyber system processes, procedures, and protocols.

Programming: standard computer software programs or applications or any usable part thereof which serve any purpose. Such programming is well known to those with ordinary skill in the art.

### GENERAL DEFINITIONS

The meanings and definitions for the following list of words and phrases shall be used when words and phrases from this list are used throughout this patent application.

Operational access: access to a cyber device for the purpose of operating the cyber device in order to use the resources of the cyber device.

Administrative access: access to a cyber device for the purpose of interacting with the administrative functions of the cyber device.

Cyber access: access to any cyber device or any cyber activity.

Cyber address: the single-point-of-access cyber system address for a cyber device.

Cyber identification: the single-point-of-access cyber system identification for an individual or a cyber device.

Computer: a physical or virtual device that at a minimum uses a processor, memory, storage, user interface, and an interconnection structure to process, access, store, modify, run, use, share, delete, or copy cyber files.

Point of cyber access computer: a single-point-of-access cyber system computer which further includes a separate private computer as well as a separate and different public computer.

Private computer: a single-point-of-access cyber system computer which is a part of an individual's point of cyber access computer. A private computer can only be accessed by the individual and can only be accessed through the individual's point of cyber access computer.

Public computer: a single-point-of-access cyber system computer which is a part of an individual's point of cyber access computer. A public computer can be accessed by others and can only be accessed through the individual's point of cyber access computer.

Cyber communication: an individual's use of single-point-of-access cyber system telephone or video telephone service, or the individual's use of single-point-of-access cyber system mail or message services.

Cyber communications network: the single-point-of-access cyber system communications network which is used for interconnected transfer of cyber interactions between cyber devices.

Cyber files: a file which requires non-biological processing for use by a cyber device.

Cyber interaction: a cyber exchange which is sent from a cyber device and is received by a separate and different cyber device.

Cyber System: any system that uses non-biological processing to achieve any purpose or function.

Cyber telephone device: an input output device which is configured to receive cyber telephone communication cyber interactions.

Cyber vault: a cyber environment where the individual who is the owner of the cyber vault can exclude cyber vault access from the cyber interactions of all others and from the cyber interactions of the cyber devices of all others. Cyber files and cyber devices including computers may be contained within a cyber vault. An individual's private computer can be considered to be the individual's cyber vault.

Cyber web site: the single-point-of-access cyber system equivalent of a prior art internet web site

Device: a mechanical or a cyber device or a combination thereof. Any device that is also a cyber device may be a virtual device or a physical device, or a combination thereof.

Frames and scrolls format: a format for creating and using interactive image based cyber content which uses the pixel resolution grid from a frame formatted image or a scroll formatted image to identify the location of an individual's interaction with that specific image.

Frame: a cyber image with a pixel resolution grid size that does not exceed the size of either of the dimensions of the pixel resolution grid of the cyber image output device where the image will be displayed.

Scroll: a cyber image with a pixel resolution grid height or width size which is larger than the corresponding height or width size of one or both of the dimensions of the pixel resolution grid of the cyber image output device where the image will be displayed.

Input output device: a cyber input device or a cyber output device or a cyber input and output device.

System: more than one process, procedure, or device which are configured together to perform or provide one or more functions.

Manage: store, access, use, make available to others, copy, remove, delete, move, name, or rename a cyber file.

Others: any individuals who are not “the individual”, “an individual”, or “said individual”.

User: an individual who uses the single point of access cyber system.

### Advantages

The following six steps embodied in the disclosed single-point-of-access cyber system solve the problems of prior art cyber systems. In addition, the steps which are embodied in the disclosed single-point-of-access cyber system solve existing problems with the prior art cyber environment.
a. each cyber device and each individual who uses the disclosed single-point-of-access cyber system will always be required to be properly identified.
b. each individual who uses the disclosed single point of access cyber system will be identified exclusively by the individual's one and only remotely accessed point of cyber access computer.
c. each individual who uses the disclosed single point of access cyber system may only gain access to the single point of access cyber system through the individual's remotely accessed point of cyber access computer.
d. the one and only remotely accessed point of cyber access computer of each individual provides and includes a separate computer for the processing and support for the individual's private cyber activities as well as another separate computer for the processing and support for the individual's public cyber activities.
e. each individual has exclusive access to the part of the individual's own point of cyber access computer which provides processing and support for the individual's private cyber activities.
f. the disclosed single-point-of-access cyber system provides cyber content and cyber devices which do not use the single-point-of-access cyber system's operating system with seamless interoperability when being used as a part of the disclosed single-point-of-access cyber system.

### Short Overview

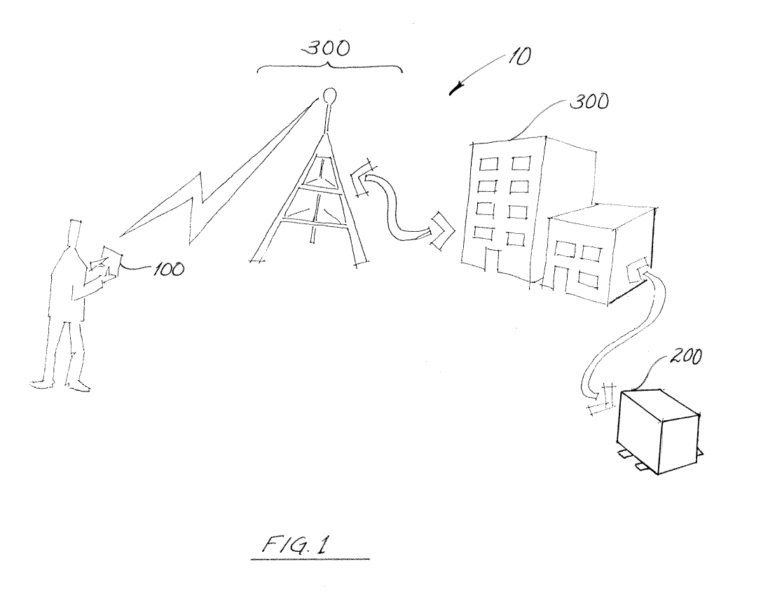

A simplified graphic representation of the disclosed single-point-of-access cyber system appears in FIG. 1.

An individual is shown using an input output device.

By use of the input output device, a cyber interaction from the properly identified individual gains access to, and is transferred through, the cyber communications network, and to the individual's point of cyber access computer where the individual's identity is properly established prior to the individual's cyber interaction gaining access to the individual's point of cyber access computer. After having gained access to the individual's point of cyber access computer, the individual, through the individual's cyber interactions, may engage in both private and public cyber activities. Private cyber activities are for the individual only. Public cyber activities involve others. By use of the disclosed system, the individual has complete access control over cyber interactions from others. The interoperability provided by the disclosed system enables the integration of interactions with any type of cyber devices into the disclosed system.

The disclosed single-point-of-access cyber system requires that each individual be properly identified prior to each step that the individual's cyber interactions take through the single-point-of-access cyber system. The disclosed single-point-of-access cyber system further requires that each cyber device be properly identified prior to each step the cyber device's cyber interactions take through the single-point-of-access cyber system. These identification requirements for the individual and for the cyber devices provide a safe, secure cyber environment for all who use the single-point-of-access cyber system. These identification requirements for the individual and for the cyber devices are also necessary to enable the disclosed single-point-of-access cyber system to provide the cyber foundation which provides an individual with the ability to have a full range of cyber personal rights as well as a full range of cyber property rights.

The disclosed single-point-of-access cyber system provides a single portal where an individual gains access to cyber interactions, to cyber communications, to the individual's cyber assets, and to cyber resources. By providing an individual with one and only one portal for access to cyber interactions, to cyber communications, to cyber activities, to the individual's cyber assets, and to cyber resources the individual is provided with enormous advantages over prior art cyber systems and prior art communications systems.

The disclosed single-point-of-access cyber system provides a standard set of cyber processes and cyber procedures for interconnected cyber interactions with remote cyber devices. This feature of the single-point-of-access cyber system provides any cyber device with the ability to be easily configured to be used as an integral part of the single-point-of-access cyber system.

The architecture, devices, processes, and procedures of the single-point-of-access cyber system provide a private, safe, secure cyber environment for use by an individual. A private, safe, secure cyber environment for an individual's cyber activities must be provided before cyber property rights and cyber privacy rights can be provided.

As compared to prior art cyber systems where most computer programs use their own unique processes, procedures, and programming, the disclosed single-point-of-access cyber system provides computer programs with standard processes, procedures, and programming. This system-wide use of standard processes, procedures, and programming provides enormous advantages for cyber system interoperability, cyber system interconnectivity, and overall cyber system simplicity.

Through the individual's use of an individual's private computer which is within the individual's point of cyber access computer, the disclosed single-point-of-access cyber system provides the individual with the ability to safely, securely, and privately store and access, use, and manage the individual's cyber-based information and the individual's file-based cyber assets. This use of the individual's private computer creates a cyber environment where cyber-based information and file-based cyber assets attain long-term value which is similar to that of their tangible counterparts.

The disclosed single-point-of-access cyber system provides an individual with the ability to selectively, safely, securely, and privately share all, or any part of, the individual's cyber-based information or file-based cyber assets with selected others. This feature of the single-point-of-access cyber system provides an individual with the ability to have full control over access by others to all, or any part of, the individual's cyber-based information or file-based cyber assets.

The requirement of the single-point-of-access cyber system that cyber interactions be pre-processed prior to being sent to a recipient drastically reduces the recipient's needs for processing resources as well as the cyber communications network's needs for cyber resources which are used for the transfer of interconnected cyber activities and cyber interactions.

The disclosed single-point-of-access cyber system's use of pre-processed cyber interactions eliminates the risk of a recipient receiving unwanted malicious content in a cyber file where the unwanted malicious content would be required to be processed by the recipient.

The disclosed single-point-of-access cyber system provides an individual with a secure, non-computer-based, input output device. The secure, non-computer-based input output device provides the individual with the ability to gain remote access to the individual's point of cyber access computer. After having been properly identified, the individual gains access to the individual's cyber telephone system, to cyber interactions with others, and to cyber interactions with the individual's cyber assets and cyber resources. The secure non-computer-based input output device, provides the individual with interconnected cyber interactions with the individual's remote point of cyber access computer.

The secure non-computer-based input output device facilitates maximum utility for the individual's use of the single-point-of-access cyber system because the secure non-computer based input output device provides the individual with the ability to gain access to the individual's point of cyber access computer from any location. Further, the non-computer-based input output device requires a minimum amount of cyber resources at the person of the individual.

The disclosed single-point-of-access cyber system provides for a complete and full-featured, yet less complex, cyber system which alters the prior art's need for more computer processing capabilities for use with future cyber system enhancements and improvements. Use of the disclosed single-point-of-access cyber system will eliminate the need for development of bigger, better, faster, and more capable cyber processors. Encryption is the backbone of prior art cyber security. However, bigger, better, faster, more capable cyber processors can eventually have capabilities to decipher encrypted cyber files thereby overcoming encryption based prior art cyber security measures.

The disclosed single-point-of-access cyber system's ability to convert cyber content and cyber interactions to and from a universal interactive operating system standard format provides any cyber device, cyber content, cyber interaction, or cyber activity which does not use the universal interactive operating system with the interoperability to interact with an individual at an input output device or to interact with a cyber device which uses the universal interactive operating system. The conversion process which is a component of the disclosed single-point-of access cyber system assures that a cyber device or cyber content or cyber interactions or cyber activities which are supported by a process for conversion to and from the universal interactive operating system format will not become obsolete.

As an example, the cyber processes and cyber procedures of the universal interactive operating system, through use of captured images from a video camera, can convert Native American Indian smoke signals to a text message, or to a voice message, or to a system command, or even to a cyber file.

As a further example, digital photos which were stored in cyber files using a prior art format from the late 1980's can be converted for interoperable use by the universal interactive operating system component of the single-point-of-access cyber system. Thus, the digital photos in a late 1980's cyber format can be used by an individual as long as the universal interactive operating system component of the single-point-of-access cyber system is made available for use by the individual.

### Expanded Overview

The disclosed single-point-of-access cyber system is a combination of processes, procedures, programs, system architecture, device architecture, and cyber devices which together provide a safe and secure cyber environment for an individual. In the provided safe and secure cyber environment an individual has interoperable access to any desired cyber function. The disclosed single-point-of-access cyber system also provides the individual with complete cyber privacy for the individual's private cyber activities. The disclosed single-point-of-access cyber system also provides the individual with varying levels of cyber privacy as specified by the individual for the individual's public cyber activities.

As shown in FIG. 1., the three primary devices which make up the single-point-of-access cyber system 10 of the present invention are an input output device 100, a point of cyber access computer 200, and a cyber communications network 300.

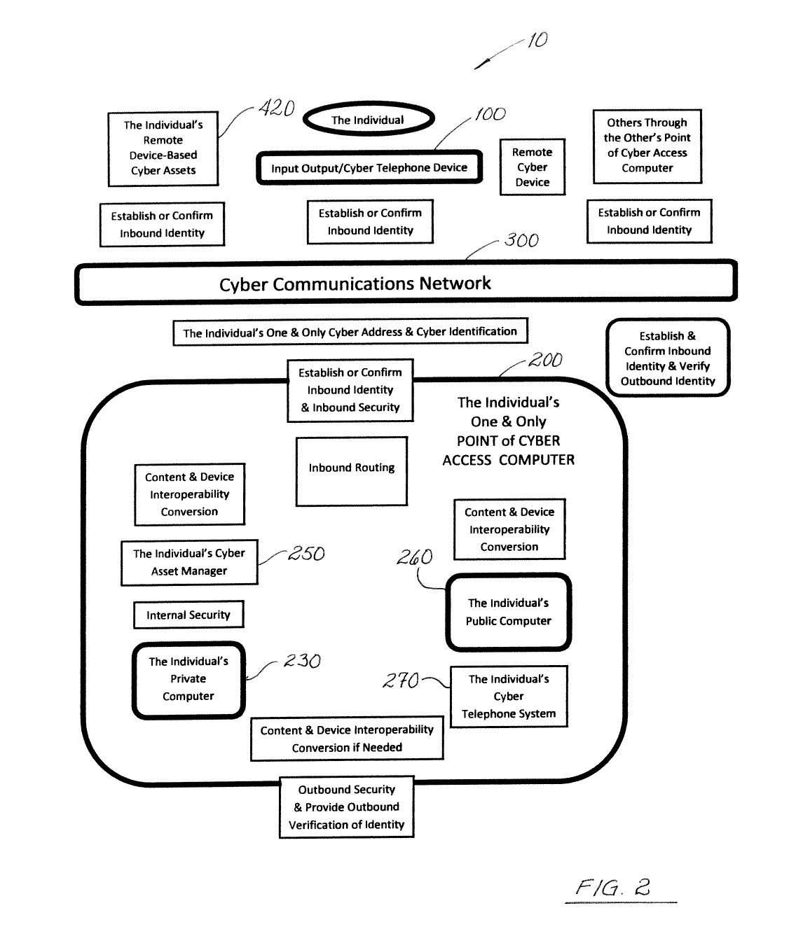

The architecture of the single-point-of-access cyber system shown in FIG. 2. establishes a concise, safe, and secure array of paths for cyber interactions among an individual, cyber assets, cyber resources, and others.

The important cyber device architectural features and system architectural features which make up the single-point-of-access cyber system are:
integration of an individual's private and public interconnected cyber activities into one system;
integration of an individual's private and public cyber activities and cyber interactions into the operations of one point of cyber access computer; and
the point of cyber access computer.

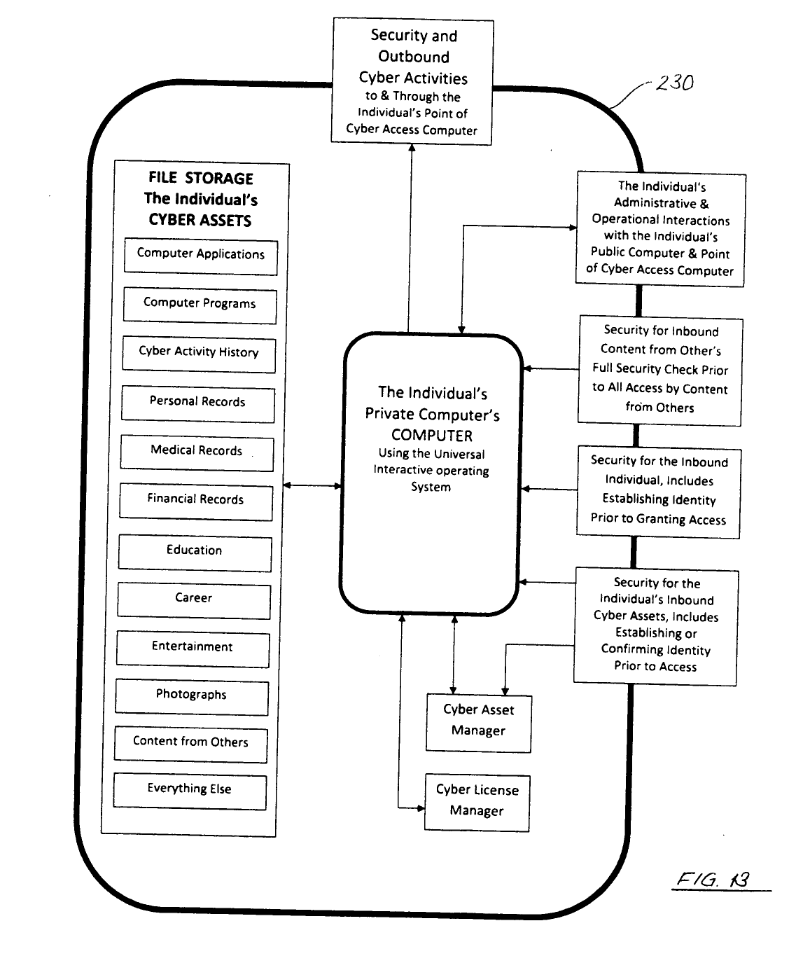

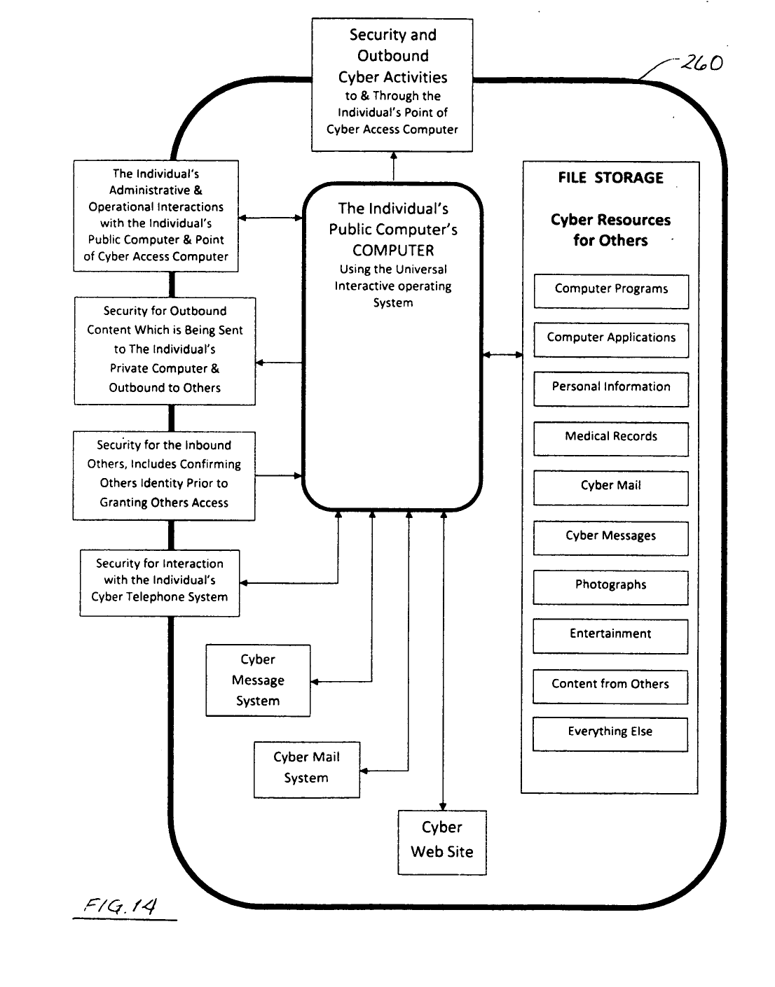

A still better understanding of the disclosed system may be had by understanding that the individual's point of cyber access computer includes a separate private computer 230 as shown in FIG. 13. and a separate public computer 260 as shown in FIG. 14. The separate private computer 230 provides separate processing and support for the individual's private cyber activities. The separate public computer 260 provides separate processing and support for the individual's public cyber activities.

The individual's separate private computer 230 serves as a cyber vault. By functioning as a cyber vault, the individual's private computer 230 provides the individual with safety, security, and privacy for all of the individual's private cyber activities.

The individual's separate public computer 260 provides for cyber interactions between the individual and others.

As shown in FIGS. 1. and 2., the single-point-of-access cyber system 10 includes a secure non-computer-based, input output device 100. The secure non-computer-based input output device provides for remote cyber interactions between the individual and the individual's point of cyber access computer.

The single-point-of-access cyber system 10 provides for storage of a lifelong collection of the individual's file-based cyber assets.

The primary processes, procedures, and programs which make up the single-point-of-access cyber system 10 are:
system-wide processes and procedures which identify each cyber device and each individual who is interacting with the disclosed single-point-of-access cyber system;
a system-wide requirement that each individual using the disclosed single-point-of-access cyber system be properly identified prior to each step the cyber interactions of the individual take through the single-point-of-access cyber system;
a system-wide requirement that each cyber device using the disclosed single-point-of-access cyber system be properly identified prior to each step each cyber interactions of the cyber device takes through the single-point-of-access cyber system;
a universal interactive operating system;
a process for creating and using interactive cyber content;
a process for providing cyber content interoperability by translating cyber content to and from a single-point-of-access cyber system cyber content format;
a procedure which requires a sender to pre-process the sender's cyber interaction prior to sending the cyber interaction to a recipient;
a process for providing cyber interaction interoperability by translating cyber interactions to and from a single-point-of-access cyber system standard cyber interaction format;
separate processing and support by a separate private computer for the private cyber activities of the individual; separate processing and support by a separate public computer for public cyber activities;
processes and procedures which exclude cyber interactions from all others and cyber interactions from the cyber devices of all others from gaining access to the individual's private computer;
processes and procedures which provide an individual with complete administrative control, operational control, and access control of the individual's point of cyber access computer, the individual's public computer, the individual's private computer, and the individual's device-based cyber assets;
processes and procedures for providing an individual with the ability to selectively grant or deny specified others access to the individual's point of cyber access computer, to the individual's cyber telephone system, to the individual's public computer, and to the individual's cyber resources which are available through the individual's public computer.

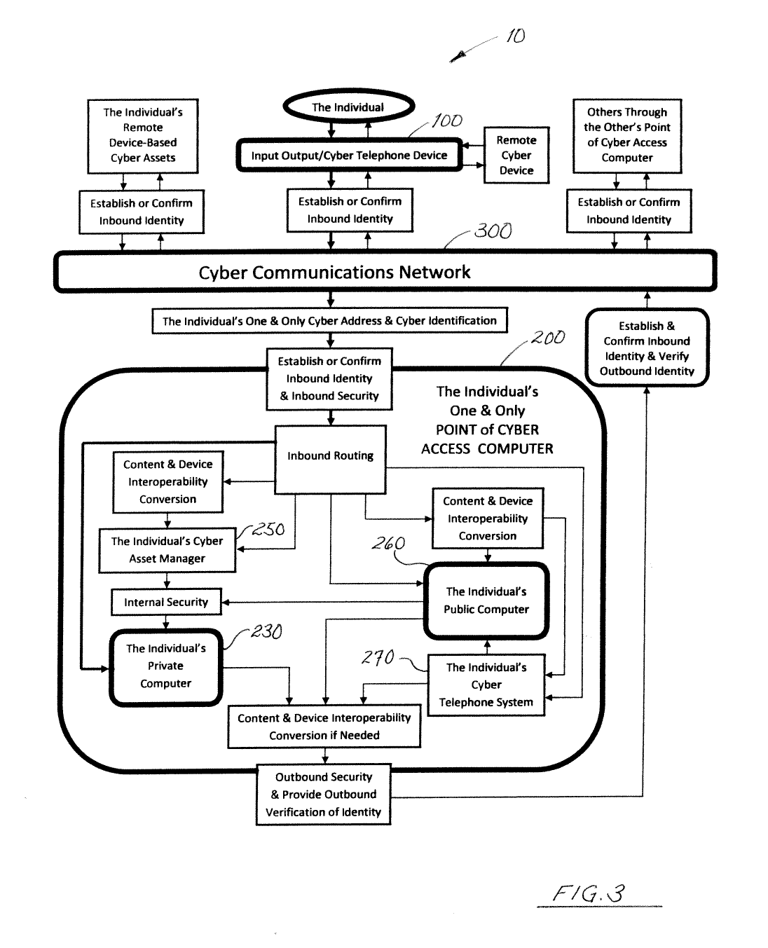

The foundation for the disclosed single-point-of-access cyber system, as shown in FIG. 3., is the requirement of the disclosed single-point-of-access cyber system 10 that each individual and each cyber device be properly identified prior to each step the cyber interactions of the individual or the cyber device take through the single-point-of-access cyber system.

This foundational requirement for proper identification of the individual, others, and every cyber device provides the safe and secure cyber environment which provides a level of cyber safety, cyber security, and cyber privacy not found in prior art systems. This foundational requirement also establishes a framework which supports cyber personal rights, cyber privacy rights, and cyber property rights.

An individual is provided only one unique lifelong single-point-of-access cyber system identification. This unique lifelong single-point-of-access cyber system identification, when combined with the single-point-of-access cyber system address of the individual's point of cyber access computer, provides all that others need to know to contact the individual for any cyber interaction or any cyber activity.

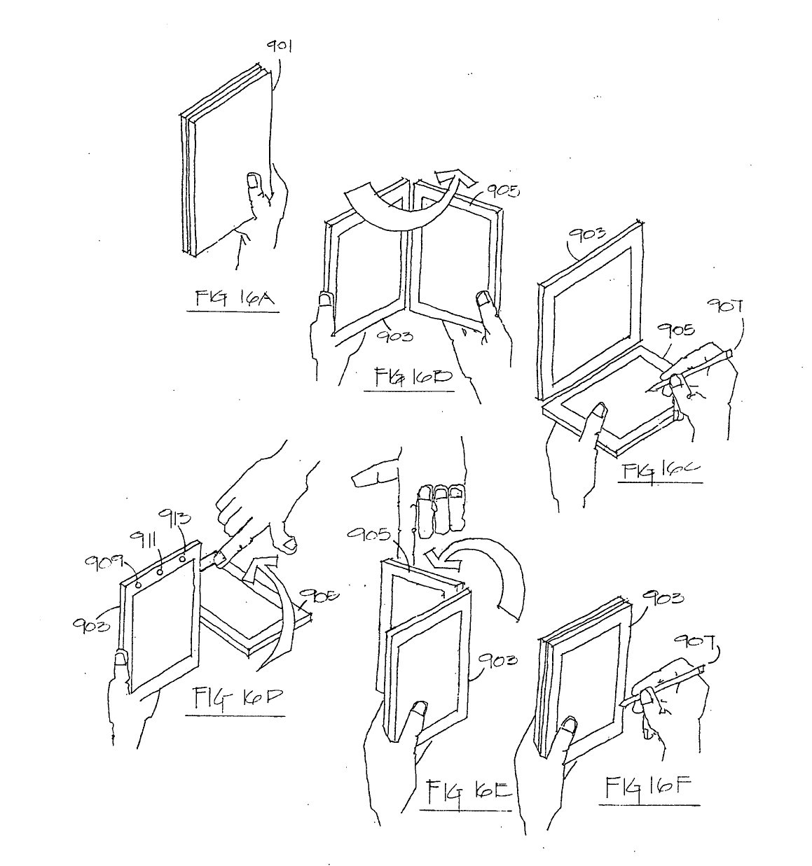

As shown in FIGS. 1., 2., and 3., the single-point-of-access cyber system 10 also includes a secure non-computer based input output device 100. The input output device 100 provides the individual with the ability to use the input output device 100 for secure remote cyber interactions with the individual's one and only point of cyber access computer 200. An example of an input output device 100 appears in FIGS. 16A., B., C., D., E., and F.

As shown in FIG. 16B, the input output device 901 may include 2 screens 903, 905 hinged together like a book. As shown in FIG. 16C, a stylus 909 may be used by the individual for interaction with the input output device. Further adaptability of the input output device appears in FIG. 16D where screen 905 may be rotated with respect to screen 903. Once rotated, screen 903 and 905 may be folded back together as shown in FIG. 16E. When folded together as in FIG. 16F. the individual may again use a stylus 909 to interact with one of the screens on the input output device. Each configuration of the input output device 901 may relate to a different functionality provided to the individual by the input output device 901.

Those with ordinary skill in the art will understand that the input output device 901 shown in FIGS. 16A., B., C., D., E., and F. is but one of many different types of devices which may serve as an input output device 100 which can be used with the disclosed single-point-of-access cyber system.

As shown in FIG. 3., an individual, through use of the input output device 100, communicates information to the individual's point of cyber access computer 200. This communication first allows the individual's point of cyber access computer FIG. to establish the individual's identity. After the individual's identity has been established by the individual's point of cyber access computer 200, the individual gains access to any of the cyber assets and the cyber resources which are available to the individual through the individual's point of cyber access computer 200.

Once the individual's identity has been established by the individual's point of cyber access computer 200, the individual's point of cyber access computer 200 provides the individual with an array of functionalities including but not limited to: computing capabilities; computer programs, computer applications; a cyber telephone; a cyber video telephone; cyber messaging; cyber mail; cyber television, cyber video entertainment; cyber radio, cyber music; verification of the individual's identity for all of the individual's public cyber activities; cyber interactions with the individual's cyber assets; cyber interactions with others; and cyber interactions with the cyber resources of others. Further, the individual is provided with operational control of the individual's point of cyber access computer's: operational functions, system access functions, systems management functions, and systems configuration functions.

The point of cyber access computer 200 includes two additional and separate computers for two separate areas of operation which are:
the individual's private computer 230, shown schematically in FIG. 13., which can only be accessed by the cyber interactions of the individual and the cyber interactions of the individual's device-based cyber assets; and
the individual's public computer 260, shown schematically in FIG. 14., which provides specified others with access to specified cyber resources which have been made available to specified others by the individual.

The private computer component 230 of the individual's point of cyber access computer 200 establishes a new dimension for an individual's cyber activities. This new dimension is a level of privacy and security is not provided by the prior art.

Only the cyber interactions of the individual and the cyber interactions of the individual's device-based cyber assets can gain access to the individual's private computer 230. Only after the individual's point of cyber access computer 200 has established the individual's identity or the identity of the individual's device-based cyber assets will access be granted to the individual's private computer 230. This means that the cyber interactions of no others can gain access to the individual's private computer 230. This feature of the single-point-of-access cyber system provides the individual with complete privacy and security for the individual's cyber activities which occur within the individual's private computer 230.

An individual's point of cyber access computer 200 contains the entire working collection of the individual's the file-based cyber assets and file-based cyber resources which are available to the individual.

Through the individual's private computer 230, the individual has access to one or more of the following: computing capabilities; computer programs; computer applications; a cyber telephone; a cyber video telephone; cyber messaging; cyber mail; cyber television, cyber video entertainment; cyber radio, cyber music; and cyber interactions with available cyber resources of others. Further, through the individual's private computer 230, the individual is provided with operational control of the individual's point of cyber access computer's, the individual's private computer's, and the individual's public computer's: system management functions; system configuration functions; and system access functions. The individual is also provided with operational control of the access control functions for the individual's cyber resources which are made available for specified others.

An individual's cyber assets include all of the individual's cyber devices, programs, applications, processes, procedures, and files which use non-biological processing.

Cyber assets are the sole property of the individual. An individual can share any part of the individual's file-based cyber assets with specified others. When the individual makes a copy of the individual's file-based cyber asset available for specified others it is made available through the individual's public computer. Copies of the individual's file-based cyber assets which are made available to specified others through the individual's public computer are called cyber resources.

An individual's file-based cyber assets include, but are not limited to, one or more of the following: personal records; financial records; health records; cyber history; photographs; cyber books; cyber magazines; music; videos; computer programs; computer applications; and cyber files of any type.

An individual's device-based cyber assets, at a minimum, consist of the individual's point of cyber access computer. The individual's device-based cyber assets can also include, but are not limited to, one or more of the following: an input output device; an audio output/video display device; a cyber telephone device; a health monitoring device; a vehicle; a cyber file backup-and-restore device; a video camera; a home or office cyber automation device which may control, and/or, monitor lights, locks, security system, thermostat, refrigerator, lawn sprinkler system, water heater operation, water or electric consumption, garage door opener, dog door, printer, private weather station, etc.; or a GPS position locating device; and those other device-based cyber assets with which an individual may interact.

As shown in FIG. 3., security processes and procedures are used for all inbound cyber activities, for all inbound cyber interactions, and for all inbound cyber content which transfer to the individual's private computer 230 from the individual's point of cyber access computer 200 or from the individual's public computer 260.

Also as shown in FIG. 3., the individual's public computer 260 is the individual's only portal for cyber interactions to and from others.

An individual's point of cyber access computer 200 provides verification of the individual's identity for the individual's outbound cyber activities and for the individual's outbound cyber interactions.

The single-point-of-access cyber system mandates that the devices within the cyber communications network 300 between the input output device 100 and the point of cyber access computer 200 which comes in first contact with a sender's cyber interactions establishes the identity of the sender's point of cyber access computer prior to transferring the sender's cyber interactions. The device within the cyber communications network 300 which comes in first contact with the sender's cyber interaction is subsequently required to provide verification of the identity of the sender's point of cyber access computer 200 prior to each step the sender's cyber interaction takes through the single-point-of-access cyber system.

For a cyber interaction from an other to gain access to the individual's point of cyber access computer 200, the individual's point of cyber access computer 200 must have received verification of the single-point-of-access cyber system identification of the other. Then the individual's point of cyber access computer 200 must confirm the other's verified identity. Once the verified identity of the other has been confirmed, the cyber interaction from the other can be granted access to the individual's point of cyber access computer 200.

Others gain access to the individual's point of cyber access computer 200 and to the individual's public computer 260 for the purposes of cyber activities and cyber interactions.

An individual has the ability, by use of the individual's separate private computer 260, to specify to whom the individual grants or denies access to:

the individual's point of cyber access computer 200;

the individual's cyber telephone system 270;

the individual's public computer 260.

Further, the individual can grant or deny each specified other access to all, or any part, of the cyber resources which are available to specified others through the individual's public computer 260.

Others who are granted access to all or part of an individual's cyber resources or to the individual's cyber telephone system, or to the individual's public computer 260 can only request that the individual or the individual's point of cyber access computer 200, or the individual's public computer 260, or the individual's private computer respond to the other's cyber interaction.

Only the individual, through cyber interactions with the individual's point of cyber access computer 200, or the individual's public computer 260, or the individual's private computer 230 may send cyber interactions from the individual's point of cyber access computer 200 to others.

Others are excluded from gaining operational, access, or administrative control of the individual's cyber resources. Further, others are excluded from gaining operational, access, or administrative control of any part of the individual's public computer 260.

Cyber interactions between the individual's point of cyber access computer 200 and the individual as shown in FIG. 3. are required to be pre-processed prior to being sent to the individual, as opposed to sending cyber interactions as files which require processing by the individual. Pre-processing of the individual's point of cyber access computer's 200 cyber interactions to the individual at an input output device 100 results in the individual, through use of the input output device 100, receiving cyber interactions. These cyber interactions can be used by the input output device 100 with no further processing of the content of the cyber interaction by the input output device 100 which is being used by the individual.

A recipient can respond to a single-point-of-access cyber system formatted cyber interaction from an individual who is a sender by communicating to the sender:
the recipient's specific input;
the specific point where the recipient's cyber interaction was made; and
the identification of the sender's specific content which was perceived by the recipient at the point in time when the recipient's cyber interaction was made.

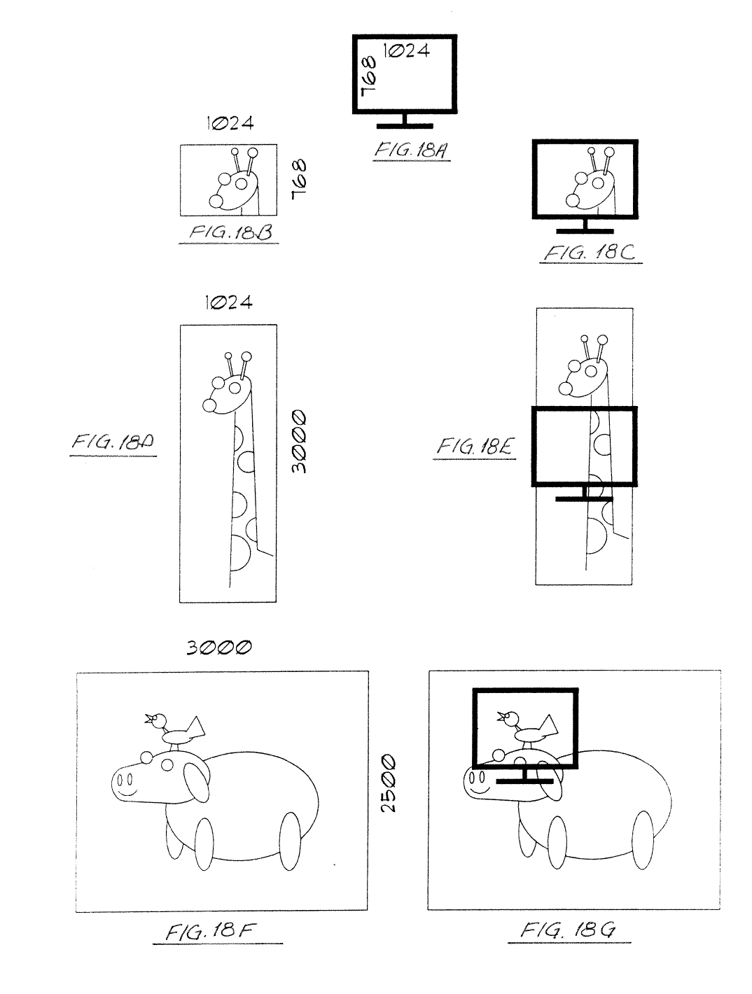

One form of image-based communication which is enabled by the disclosed system is a frames and scrolls format for image-based cyber content. Using the visual frames-and-scrolls format as shown in the array of images in FIG. 18. for image-based single-point-of-access cyber system content, a recipient can respond to a cyber interaction from the sender by communicating the recipient's specific input at the specific point on the specific image which the recipient received on the input output device which is being used by the recipient.

Shown in FIG. 18A. is a screen which is similar to screens 903 and 905 shown in FIG. 16. The size of the screen is 1024 pixels by 768 pixels. Thus, an image having a height dimension larger than 768, such as the 1024 pixels by 3000 pixels image shown in FIG. 18D., will not appear on a 1024×768 image display screen in its entirety. Rather, only a portion of the image shown in FIG. 18D. will appear on a screen such as shown in FIG. 18E., or in FIG. 18G. using the disclosed frames and scrolls format. As shown in FIGS. 18E. and 18G., the disclosed scrolls format may be used when one or two image dimensions are larger than what can appear on a single screen.

As shown in FIG. 3., an individual's point of cyber access computer 200 may also include a cyber telephone system 270. The cyber telephone system 270 provides for all aspects of the individual's needs or desires for cyber telephone communication services. The individual's cyber telephone system 270:
provides a history of cyber telephone system activities;
grants or denies cyber telephone communication cyber interactions from others access to all or any part of the individual's cyber telephone system;
routes cyber telephone communications cyber interactions, and related cyber alerts, to an input output/cyber telephone device which is on, or near, the individual, or which is specified for contact by the individual;
records messages from inbound cyber telephone communications cyber interactions;
deliver messages to specified others;
provide any other cyber telephone services or functions which are required or desired by the individual.

A key feature of the disclosed single-point-of-access cyber system 10 is that it has differences among operations, processes, code, transfer packets, and formats for: cyber interactions; cyber telephone communications; cyber mail; cyber messages; cyber television; cyber video entertainment; cyber music; file transfers; computer programs, computer applications; operational controls; and any other required or desired function. The reason for the differences among operations, processes, code, transfer packets, and formats which provide for security between different processes is to assure proper routing, and to assure that cyber interaction for one specific purpose can not and will not be used for a different purpose.

The single-point-of-access cyber system cyber communications network 300 requires that an individual be properly identified prior to each step the individual's cyber interactions take through the single-point-of-access cyber system cyber communications network 300.

The single-point-of-access cyber system cyber communications network 300 requires each cyber device be properly identified prior to each step the cyber device's cyber interactions take through the single-point-of-access cyber system cyber communications network 300.

The single-point-of-access cyber system 10 requires all cyber activities to be properly formatted. Further, the single-point-of-access cyber system 10 requires all cyber activities keep a history of each step the cyber activities take through the cyber communications network 300 and through the single-point-of-access cyber system 10.

The single-point-of-access cyber system 10 has policies, procedures, and devices which are used for cyber interaction among the individual, the individual's point of cyber access computer 200, the individual's private computer 230, and the individual's remote device-based cyber assets. These policies, procedures, and devices provide for safe and secure cyber interactions between remote device-based cyber assets and the individual or the individual's private computer 230 or the individual's point of cyber access computer 200. In addition, these policies, procedures, and devices exclude all others from gaining access to the individual's cyber assets.

Another key feature of the disclosed single-point-of-access cyber system 10 is the universal interactive operating system. The programming which makes up the universal interactive operating system provides processes and procedures. The processes and procedures provide an interoperable interconnected cyber environment. Within the interoperable cyber environment any cyber device can use the safety and security of the single-point-of-access cyber system 10 for interconnected cyber interactions.

It makes no difference which operating system is used by a sender of a cyber interaction or which operating system is used by the recipient of a cyber interaction as long as the cyber interaction between the sender and the recipient uses the universal interactive operating system of the disclosed system for interoperable interconnection.

The universal interactive operating system which is used in the disclosed single-point-of-access cyber system has interoperability processes which translate cyber interactions, cyber activities, and cyber content to and from standard universal interactive operating system format.

The individual's point of cyber access computer 200, the individual's private computer 230, and the individuals' public computer 260 keep a history of all cyber activities from within the cyber domain of the individual.

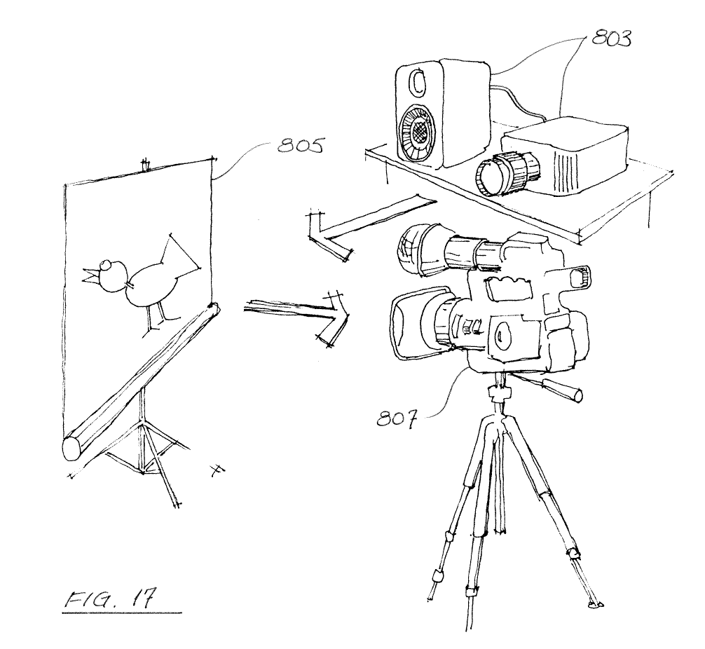

As shown in FIG. 17., the universal interactive operating system includes resource-efficient processes and procedures which use one or more virtual projectors 803, and one or more virtual projection display screens 805, and one or more virtual recorders or capture devices 807 to: convert cyber content for interoperability; convert cyber interactions for interoperability; alter images; alter audio; converge two or more sources of image-based cyber content into one or more converged sources of image-based cyber content.

### Single-Point-Of-Access Cyber System Architecture

As shown in FIG. 2., the architecture of the disclosed single-point-of-access cyber system 10 defines the interrelationship of the components of the disclosed single-point-of-access cyber system 10. The architecture of the single-point-of-access cyber system 10 also defines the components of the disclosed single-point-of-access cyber system 10. Specifically the components of the single-point-of-access cyber system 10 include architectural rules and requirements, system structure, one or more point of cyber access computers 200, one or more input output devices 100, one or more cyber devices, a cyber communications network 300, and a universal interactive operating system. Optionally, the components of the single-point-of-access cyber system 10 can further include one or more cyber asset managers 250 and one or more cyber telephone systems 270.

The architecture of the disclosed single-point-of-access cyber system 10 provides architecture for a cyber system in which one or more point of cyber access computers 200, and one or more input output devices 100, and one or more cyber devices have cyber interactions using the cyber communications network 300 and the universal interactive operating system.

The device architecture which is a part of the disclosed single-point-of access cyber system provides for a point of cyber access computer 200, or a private computer 230, or a public computer 260, or a cyber device with the ability to be a physical device, to be a virtual device, or to be a combination thereof.

The architecture of the disclosed single-point-of-access cyber system provides for the addition of, and the removal from, and the reconfiguration of the arrangement of, the cyber processes and the cyber procedures of the single-point-of-access cyber system 10.

The architecture of the disclosed single-point-of-access cyber system provides for the addition of, the removal from, and the reconfiguration of the arrangement of, cyber components and cyber devices which are a part of the single-point-of-access cyber system.

The architecture of the disclosed single-point-of-access cyber system provides device architecture. The device architecture in turn provides for separate processing and support for an individual's private cyber activities, as well as separate and different processing and support for an individual's public cyber activities.

The device architecture of the disclosed single-point-of-access cyber system 10 further provides for a point of cyber access computer 200 which is a combination of three separate, yet interconnected computers. The first computer is the point of cyber access computer 200; the second computer is a private computer 230; and the third computer is a public computer 260. The three separate computers can be integrated into one single device, or, one or more of the three separate computers may be physically separate computers which may also be physically located at one or more locations.

The device architecture of the disclosed single-point-of-access cyber system 10 provides for the addition of, the removal from, and the reconfiguration of the arrangement of: the components, the cyber processes, and the cyber procedures of a single-point-of-access cyber system cyber device.

The architecture of the disclosed single-point-of-access cyber system provides system-standard interface and interaction cyber processes and cyber procedures. The system-standard interface and interaction cyber processes and cyber procedures provide an environment of cyber interoperability where any cyber device can be seamlessly used as a part of the single-point-of-access cyber system.

According to the architectural rules and regulations of the disclosed single-point-of-access cyber system, it is an absolute requirement that the individual's point of cyber access computer 200 establishes or confirms the identity of the individual, or the identity of others, or the identity of a cyber device prior to providing point of cyber access computer access to cyber interactions from the individual, or from others, or from a cyber device.

It is also an absolute requirement of the architectural rules and regulations of the architecture of the disclosed single-point-of-access cyber system that proper identification of each individual is made prior to each step the cyber interactions of the individual take through the single-point-of-access cyber system. The architectural rules and regulations also require proper identification of each cyber device prior to each step that the cyber interactions of the cyber device take through the single-point-of-access cyber system.

The architectural rules and regulations require that an individual's private computer can only be accessed by cyber interactions from the individual or by cyber interactions from the individual's device-based cyber assets. Further, the architectural rules and regulations require that the individual's private computer can only be accessed through the individual's point of cyber access computer.

The architectural rules and regulations provide for an individual's public computer to be accessed by cyber interactions from others who have been granted access by the individual. Further, the individual's public computer can only be accessed through the individual's point of cyber access computer.

The architecture of the disclosed single-point-of-access cyber provides:
a single interconnected cyber system for use by an individual for the individual's cyber interactions and cyber activities;
a system-wide set of standard cyber processes and cyber procedures;
a cyber system which requires each individual and each cyber device which uses the cyber system to always be properly identified;
a remote point of cyber access computer for use by each individual who uses the single-point-of-access cyber system;
an individual with the ability to remotely access cyber assets and cyber resources.

### Universal Interactive Operating System

The universal interactive operating system is the single-point-of-access cyber system's master control program. The universal interactive operating system provides the device operating systems for many of the cyber devices which make up the single-point-of-access cyber system.

The universal interactive operating system provides programming which provides processes and procedures which provide a cyber environment wherein cyber activities of every type can be integrated into one world-wide interconnected cyber system which uses the universal interactive operating system as a primary operating system.

The universal interactive operating system provides programming which provides and enables the processes and procedures which provide an individual with the ability to consolidate access to all of the individual's cyber activities into one remotely accessible device. This one remotely accessible device is the individual's one and only point of cyber access computer.

The universal interactive operating system provides programming which provides and enables the processes and procedures which provide a cyber environment where cyber activities and cyber devices of every type can be accessed and used by an individual through the individual's use of an input out device in conjunction with the individual's use of the individual's point of cyber access computer.

The universal interactive operating system is designed to minimize the number of system-wide operational processes and procedures which are provided and used by others. This minimization of the number of system-wide operational processes and procedures is accomplished by providing and requiring the system-wide use of standard operational processes and procedures by others.

The universal interactive operating system provides programming for device operating systems for:
point of cyber access computers;
private computers;
public computers;
input output devices;
cyber telephone devices;
cyber communications network devices; and
any other single-point-of-access cyber system device which requires an operating system.

The universal interactive operating system provides programming which provides and enables the processes and procedures which both require and provide processes and procedures to assure that each individual is properly identified prior to each step the cyber interactions of that individual take through the single-point-of-access cyber system. The processes and procedures requiring identification further assure that each cyber device is properly identified prior to each step the cyber device's cyber interactions take through the single-point-of-access cyber system.

The universal interactive operating system provides programming which provides and enables the processes and procedures which provide an individual or a cyber device with the ability to establish identity, confirm identity, or provide verification of the identity of an individual, or of a cyber device.

The universal interactive operating system provides programming which provides and enables the processes and procedures which provide a cyber environment wherein each cyber device which is a part of the single-point-of-access cyber system must properly identify each individual and each cyber device prior to having further cyber interactions with the properly identified individual or the properly identified cyber device.

The universal interactive operating system provides programming which provides and enables the processes and procedures which provide an individual's point of cyber access computer with the ability to establish the individual's identity.

The universal interactive operating system provides programming which provides and enables the processes and procedures which require and provide processes and procedures to assure that an individual's point of cyber access computer establishes the individual's identity prior to further cyber interactions between the individual and the individual's point of cyber access computer.

The universal interactive operating system provides programming which provides and enables the processes and procedures which require and provide for an individual's point of cyber access computer to provide others and the cyber devices of others with verification of the individual's identity prior to each step that the individual's cyber interactions take through the single-point-of-access cyber system.

The universal interactive operating system provides programming which provides and enables the processes and procedures which require an individual's point of cyber access computer to establish the identity of the individual's device-based cyber assets, and, for the individual's device-based cyber assets to establish the identity of the individual's point of cyber access computer prior to any further cyber interactions between the individual's point of cyber access computer and the individual's device-based cyber assets.

The universal interactive operating system provides programming which provides and enables the processes and procedures which provide an individual's point of cyber access computer with the ability to confirm the verified identity of others and the verified identity of the cyber devices of others prior to further cyber interactions with others or with the cyber devices of others.

The universal interactive operating system provides programming which provides and enables the processes and procedures which require and provide for devices within the cyber communications network to establish the identity of an individual's point of cyber access computer upon the individual's point of cyber access computer's first interaction with the cyber communications network.

The universal interactive operating system provides programming which provides and enables the processes and procedures which require the device within a cyber communications network which establishes the identity of an individual's point of cyber access computer to in turn provide verification of the identity of the individual's point of cyber access computer prior to each step the individual's cyber interactions take through the single-point-of-access cyber system.

The universal interactive operating system provides programming which provides and enables the processes and procedures which provide an input output device with the ability to capture identity information in regard to an individual, then transfer the identity information as a cyber interaction to the individual's point of cyber access computer where the cyber interaction containing captured identity information about the individual can be used by the individual's point of cyber access computer to establish the individual's identity.

The universal interactive operating system provides programming which provides and enables the processes and procedures which provide an individual with the ability to use the single-point-of-access cyber system identification of an other, or the single-point-of-access cyber system identification the device-based cyber assets of another, to obtain additional information about the other or to obtain additional information about the other's device-based cyber assets.

The universal interactive operating system provides programming which provides and enables the processes and procedures which require and assure that there is no duplicate use of any one single-point-of-access cyber system identification.

The universal interactive operating system provides programming which provides and enables the processes and procedures which require there are no individuals who have more than one single-point-of-access cyber system identification and that there are no cyber devices which have more than one single-point-of-access cyber system identification.

The universal interactive operating system provides programming which provides and enables the processes and procedures which provide operating-system-based cyber security functions and services for the single-point-of-access cyber system.

The universal interactive operating system provides programming which provides and enables the processes and procedures which require and provide processes for providing security for all inbound cyber interactions and cyber activities directed to an individual's point of cyber access computer.

The universal interactive operating system provides programming which provides and enables the processes and procedures which require and provide processes for providing security for all internal cyber interactions and cyber activities within an individual's point of cyber access computer.

The universal interactive operating system provides programming which provides and enables the processes and procedures which require and provide processes for providing security for all outbound cyber interactions and cyber activities from an individual's point of cyber access computer.

The universal interactive operating system provides programming which provides and enables the processes and procedures which provide an individual with the ability to manage security at each of the individual's device-based cyber assets including the individual's point of cyber access computer, the individual's private computer, the individual's public computer, and the individual's cyber telephone system.

The universal interactive operating system provides programming which provides and enables the processes and procedures which provide differences among cyber operations, processes, codes, transfer packets, and formats for cyber interactions for: cyber telephone communications; cyber mail; cyber messages; cyber television; cyber video entertainment; cyber music; file transfers; computer programs; computer applications; operational controls; and any other needed or desired functions. The differences among cyber operations, cyber processes, codes, transfer packets, and formats for cyber interactions for: cyber telephone communications; cyber mail; cyber messages; cyber television; cyber video entertainment; cyber music; file transfers; computer programs; computer applications; operational controls; and any other needed or desired functions. The differences among cyber operations, processes, codes, transfer packets, and formats provides for security between different processes, assures proper routing, and assures that a cyber interaction for one specific purpose cannot be used for a different purpose.

The universal interactive operating system provides programming which provides and enables the processes and procedures which inspect inbound cyber interactions to determine if the inbound cyber interactions contain dangerous or malicious or inappropriate or unwanted content.

The universal interactive operating system provides programming which provides and enables the processes and procedures which deny further access to inbound cyber interactions which contain dangerous or malicious or inappropriate or unwanted content.

The universal interactive operating system provides programming which provides and enables the processes and procedures which provide:
safe and secure cyber interactions between the individual's private computer and the individual's point of cyber access computer;
safe and secure cyber interactions between the individual's private computer and the individual's public computer;
safe and secure cyber interactions between the individual's private computer and the individual's device-based cyber assets;
and safe and secure cyber interactions between the individual's private computer and the individual's cyber telephone system.

The universal interactive operating system provides programming which provides and enables the processes and procedures which require and provide processes for providing security for:
interactions with operations of an individual's device-based cyber assets;
interactions with operations of an individual's file-based cyber assets;
interactions with operations of an individual's cyber resources.

The universal interactive operating system provides programming which provides and enables the processes and procedures which provide for and require that security-based administrative cyber interactions occur between single-point-of-access cyber system devices as an integral part of a corresponding cyber interaction which is being transferred between the same two single-point-of-access cyber system devices.

The universal interactive operating system provides programming which provides and enables the processes and procedures which provide a system-wide protocol. The system-wide protocol requires others to have the ability to only request that an individual provide an other with a requested cyber interaction. The system-wide protocol further requires that the individual either directly, or through automated interaction from the individual's cyber devices, have the exclusive ability to send others cyber interactions from the individual, or from the individual's point of cyber access computer, or from the individual's public computer, or from the individual's cyber telephone system. No others have the ability to send cyber interactions from the individual, or from the individual's point of cyber access computer, or from the individual's public computer, or from the individual's cyber telephone system.

The universal interactive operating system provides programming which provides and enables the processes and procedures which require and provide for the deletion of any cyber interaction which was from an individual or from a cyber device which cannot be properly identified.

The universal interactive operating system provides programming which provides and enables the processes and procedures which provide for the identification of, and the deletion of cyber interactions which contains dangerous, or malicious, or inappropriate, or unwanted, or improperly labeled contents.

The universal interactive operating system provides programming which provides and enables the processes and procedures which use the combination of one or more virtual projectors, one or more virtual projection display screens, and one or more virtual recorders or capture devices to provide cyber security by converting cyber content from cyber interactions which are not in universal interactive operating system standard image-based cyber content format to cyber interactions which are in universal interactive operating system standard image-based cyber content format.

The universal interactive operating system provides programming which provides processes and procedures which provide encryption or other suitable cyber security processes and cyber security procedures for use with any desired cyber interaction or cyber activity.

The universal interactive operating system provides programming which provides and enables the processes and procedures which require and provide encryption or other suitable cyber security processes and cyber security procedures be used for cyber interactions which use radio frequency for cyber communication.

The universal interactive operating system provides programming which provides and enables the processes and procedures for backing up stored information from, as well as restoring backed up information to:

an individual's point of cyber access computer;

an individual's private computer;

an individual's public computer;

an individual's cyber telephone system;

an individual's device-based cyber assets.

The universal interactive operating system provides programming which provides and enables the processes and procedures for providing safe, secure, and private cyber financial interactions, cyber financial transactions, and operations of cyber-based financial record keeping systems.

The universal interactive operating system provides programming which provides and enables the processes and procedures which provide safe, secure, and private cyber interactions between an individual through the individual's point of cyber access computer and any health care related device or any health care related resource which is being relied upon by the individual.

The universal interactive operating system provides programming which provides and enables the processes and procedures which provide the ability to use varying levels of security for access to, and operations of, different parts and operations of the single-point-of-access cyber system.

The universal interactive operating system provides programming which provides and enables the processes and procedures which provide an individual with the ability to selectively grant or selectively deny cyber interactions from specified others, or cyber interactions from the specified cyber devices of specified others, access to the individual's point of cyber access computer, access to the individual's cyber telephone system, and access to the individual's public computer.

The universal interactive operating system provides programming which provides and enables the processes and procedures which provide an individual with the ability to make copies of the individual's file-based cyber assets available for specified others as cyber resources. Cyber resources are made available to specified others through the individual's public computer.

The universal interactive operating system provides programming which provides and enables the processes and procedures providing an individual with the ability to selectively grant or selectively deny cyber interactions from specified others, or cyber interactions from the cyber devices of specified others, access to all or any part of the cyber resources which have been made available for specified others through the individual's public computer.

The universal interactive operating system provides programming which provides and enables the processes and procedures which provide an individual with the ability to safely and securely provide specified others specified levels of administrative control, or specified levels of access control, or specified levels of operational access control of all, or any part of, the individual's point of cyber access computer, the individual's private computer, the individual's public computer, the individual's device-based cyber assets, the individual's file-based cyber assets, or the individual's cyber telephone system.

The universal interactive operating system provides programming which provides and enables the processes and procedures which provide an individual with the ability to provide specified others with specified cyber resources, specified cyber content, and specified cyber services of any type.

The universal interactive operating system provides programming which provides and enables the processes and procedures which convert cyber interaction output from cyber devices which use the universal interactive operating system to cyber interaction output which interacts seamlessly with the operating systems of cyber devices which do not use the universal interactive operating system component of the disclosed single-point-of-access cyber system.

The universal interactive operating system provides programming which provides and enables the processes and procedures which convert cyber interaction output from cyber devices which do not use the universal interactive operating system to cyber interaction output which interacts seamlessly with cyber devices which use the universal interactive operating system component of the disclosed single-point-of-access cyber system.

The universal interactive operating system provides programming which provides and enables the processes and procedures which provide interoperability processes to convert cyber content which is not in a format which can directly be used by the single-point-of-access cyber system to cyber content which is in the standard universal interactive operating system format.

The universal interactive operating system provides programming which provides and enables the processes and procedures which provide interoperability processes which convert cyber content which is in a standard universal interactive operating system format to cyber content which is in a format which can be used by a cyber device using an operating system other than the universal interactive operating system portion of the disclosed invention. The combination of this and the previous three processes and procedures is the reason the interactive operating system is described as being universal.

The universal interactive operation system provides programming which provides and enables the processes and procedures which provides an environment of cyber interoperability. The environment of cyber interoperability provides an individual with the ability to access and interact with any available cyber device or any available cyber content.

The universal interactive operating system provides programming which provides and enables the processes and procedures which use one or more virtual projectors, one or more virtual projection display screens, and one or more virtual recorders or capture devices to convert inbound image-based cyber content that does not use the universal interactive operating system standard image-based cyber content format to image-based cyber content which does use the universal interactive operating system standard image-based cyber content format.

The universal interactive operating system provides programming which provides and enables the processes and procedures which provide for safe and secure cyber interactions with content and device interoperability conversion processes.

The universal interactive operating system provides programming which provides and enables the processes and procedures which provide for safe and secure cyber interactions with output from content and device interoperability conversion processes.

The universal interactive operating system provides programming which provides and enables the processes and procedures which convert administrative cyber interactions and systems configuration cyber interactions between cyber devices to and from system-standard universal interactive operating system format.

The universal interactive operating system provides programming which provides and enables the processes and procedures which identify inbound or outbound cyber interactions which require content or device interoperability conversion.

The universal interactive operating system provides programming which provides and enables the processes and procedures which provide an individual with the ability to use operating systems other than universal interactive operating system which is a part of the single-point-of-access cyber system of the disclosed invention. The individual may require the use of an operating system other than the universal interactive operation system of the disclosed invention for the purpose of converting cyber content and cyber interactions that use operating systems other than the universal interactive operating system to cyber content and cyber interactions which use the universal interactive operating system of the disclosed invention. Further, the individual may require the use of an operating system other than the universal interactive operating system of the disclosed invention for the purpose of using computer programs or computer applications which require the use of an operating system other than the universal interactive operating system of the disclosed invention.

The universal interactive operating system provides programming which provides and enables the processes and procedures which exclude all others and the cyber devices of all others from gaining operational control, or administrative control, or access control of an individual's point of cyber access computer, or the individual's private computer, or the individual's device based cyber assets.

The universal interactive operating system provides programming which provides and enables the processes and procedures which exclude all others and the cyber devices of all others from gaining administrative control, or access control of an individual's public computer, or of the individual's cyber telephone system.

The universal interactive operating system provides programming which provides and enables the processes and procedures which provide for the use of outbound cyber interactions which have been pre-processed by the sender. The pre-processed cyber interactions of the sender are ready to be used by the recipient at a non-computer-based input output device with no further content processing required by the recipient.

The universal interactive operating system provides programming which provides and enables the processes and procedures which require and provide for a sender to pre-process outbound cyber interactions.

The universal interactive operating system provides programming which provides and enables the processes and procedures which require and provide for cyber interactions which are sent from an individual's point of cyber access computer to the individual at a non-computer based input output device to be pre-processed cyber interactions which require no further processing of content prior to use by the individual at the non-computer based input output device.

The universal interactive operating system provides programming which provides and enables the processes and procedures requiring and providing for the use of single-point-of-access cyber system addresses and single-point-of-access cyber system identifications for each step of each cyber interaction.

The universal interactive operating system provides programming which provides and enables the processes and procedures which provide an individual with the ability to request or require that others provide the individual with cyber interactions and cyber content which complies with the individual's preferences or requirements for cyber interactions and for cyber content.

The universal interactive operating system provides programming which provides and enables the processes and procedures which provide an individual with the ability to request or require others provide the individual with varying levels of privacy, as defined by the individual, for the individual's cyber interactions with others.

The universal interactive operating system provides programming which provides and enables the processes and procedures which provide an individual with the ability to add cyber components and cyber devices to the single-point-of-access cyber system, to remove cyber components and cyber devices from the single-point-of-access cyber system, and to change the configuration of the cyber components and the cyber devices of the single-point-of-access cyber system.

The universal interactive operating system provides programming which provides and enables the processes and procedures which provide an individual with the ability to:
add processes and procedures to the single-point-of-access cyber system;
remove processes and procedures from the single-point-of-access cyber system;
change the configuration of the processes and the procedures of the single-point-of-access cyber system.

The universal interactive operating system provides programming which provides and enables the processes and procedures which provide an individual with the ability to:
add cyber processes and cyber procedures and components to a cyber device;
remove cyber processes and cyber procedures and components from a cyber device;
change the configuration of the cyber processes and the cyber procedures and the components of a cyber device.

The universal interactive operating system provides programming which provides and enables the processes and procedures which allow an individual's single-point-of-access cyber system cyber devices, cyber components, cyber processes, and cyber procedures to be configured in any possible way. Providing an individual with the ability to re-configure the individual's single point-of-access cyber system cyber devices, cyber components, cyber processes, and cyber procedures provides for the varying needs and desires of different and unique individuals. Further, individuals who are entities such as businesses, or schools, or governments, or any other type of entity which uses a single-point-of-access cyber system identification can have many different and specific needs for single-point-of-access cyber system cyber devices, cyber components, cyber processes, cyber procedures, and cyber system configurations.

The universal interactive operating system provides programming which provides and enables the interoperability cyber processes and cyber procedures which provide an individual with the ability to seamlessly use any non-system-standard cyber activity, or any non-system-standard cyber process, or any non-system-standard cyber device which the individual may require or desire.

The universal interactive operating system provides programming which provides and enables the processes and procedures which provide for the interrelationship between the cyber components, the cyber devices, the cyber processes, and the cyber procedures of the single-point-of-access cyber system.

The universal interactive operating system provides programming which provides and enables the processes and procedures which provide for cyber interactions between the cyber components, the cyber devices, the cyber processes, and the cyber procedures of the single-point-of-access cyber system.

The universal interactive operating system provides programming which provides and enables the processes and procedures which provide an individual with a perceptible output which are the result of the cyber interactions of the individual at an input output device.

The universal interactive operating system provides programming which provides and enables the processes and procedures which provide an individual with operational access to the individual's point of cyber access computer from any remote input output device which can provide adequate information to the individual's point of cyber access computer to allow the individual's point of cyber access computer to establish the individual's identity.

The universal interactive operating system provides programming which provides and enables the processes and procedures which provide seamless cyber interactions when an input output device is simultaneously used for two or more different cyber activities.

The universal interactive operating system provides programming which provides and enables the processes and procedures which provide for cyber interactions with input devices of any type and output devices of any type.

The universal interactive operating system provides programming which provides and enables the processes and procedures which provide a graphic user interface using frames and scrolls formatted image-based cyber content in conjunction with the processes which use one or more virtual projectors, one or more virtual projection display screens, and one or more virtual recorders or capture devices for conversion of, alteration of, or convergence of image-based cyber content.

The universal interactive operating system provides programming which provides and enables the processes, procedures, and programming which makes up the device operating system for a point of cyber access computer.

The universal interactive operating system provides programming which provides and enables the processes and procedures which enable a point of cyber access computer to include a separate private computer and to also include a separate public computer; the separate private computer and separate public computers are both part of the point of cyber access computer.

The universal interactive operating system provides programming which provides and enables the processes and procedures which provide a cyber system which routes cyber interactions and cyber activities within a point of cyber access computer.

The universal interactive operating system provides programming which provides and enables the processes and procedures which provide an individual with the ability to use any input output device for cyber interactions with the individual's point of cyber access computer.

The universal interactive operating system provides programming which provides and enables the processes and procedures which provide an individual's point of cyber access computer with the ability to independently have cyber interactions with others based on predetermined operational settings, predetermined administrative settings, and predetermined access settings which were provided to the individual's point of cyber access computer by the individual.

The universal interactive operating system provides programming which provides and enables the processes, procedures, and programming which makes up the device operating system for a private computer.

The universal interactive operating system provides programming which provides and enables the processes and procedures which provide an individual with a private computer which can only be accessed by the individual or the individual's device-based cyber assets.

The universal interactive operating system provides programming which provides and enables the processes and procedures which exclude all others, as well as the cyber devices of all others, from having cyber interactions with an individual's private computer. Because all others and the cyber devices of all others are excluded from having cyber interactions with the individual's private computer, the individual's private computer provides the individual with a cyber environment which is safe, secure, private, and free from intrusion by others as described above. The individual's private computer can also be considered to be a cyber vault.

The universal interactive operating system provides programming which provides and enables the processes and procedures which provide safe and secure cyber interactions between an individual's private computer and all cyber activities and all cyber interactions from within the individual's point of cyber access computer.

The universal interactive operating system provides programming which provides and enables the processes and procedures which provide an individual with the ability to use the individual's private computer to run and use computer programs and to run and use computer applications.

The universal interactive operating system provides programming which provides and enables the processes and procedures which provide an individual with the ability to store, access, use, and manage a lifelong collection of file-based cyber assets from within the individual's private computer.

The universal interactive operating system provides the processes, procedures, and programming of the device operating system for a public computer.

The universal interactive operating system provides programming which provides and enables the processes and procedures which provide processes for an individual's public computer to use to independently have cyber interactions with others based on predetermined operational settings, predetermined administrative settings, and predetermined access settings which were provided for the individual's public computer by the individual.

The universal interactive operating system provides programming which provides and enables the processes and procedures for an individual to use to receive and to store cyber interactions and cyber content from others through use of the storage capabilities of the individual's public computer.

The universal interactive operating system provides programming which provides and enables the processes and procedures which provide an individual with the ability to selectively grant or to selectively deny others or the cyber devices of others access to the individual's public computer.

The universal interactive operating system provides programming which provides and enables the processes and procedures which provide an individual with the ability to selectively grant or to selectively deny specified others or the specified cyber devices of specified others access to all or any part of the cyber resources which are available for specified others through the individual's public computer.

The universal interactive operating system provides programming which provides and enables the processes and procedures which provide for all aspects of operations of, and interaction with, a safe, a secure, and a full-featured cyber telephone.

The universal interactive operating system provides programming which provides and enables the processes and procedures which provide an individual's cyber telephone system with the ability to independently interact with others based on predetermined operational settings, predetermined administrative settings, and predetermined access settings which were provided for the individual's cyber telephone system by the individual.

The universal interactive operating system provides programming which provides and enables the processes and procedures for all aspects of operations of, and for cyber interactions with, a safe, a secure, and a full-featured cyber asset manager.

The universal interactive operating system provides programming which provides and enables the processes and procedures which exclude an individual's device-based cyber assets from having cyber interactions with others.

The universal interactive operating system provides programming which provides and enables the processes and procedures which exclude all others from having cyber interactions with an individual's device-based cyber assets.

The universal interactive operating system provides programming which provides and enables the processes and procedures which provide an interoperable cyber environment wherein interconnected cyber devices of any type can be seamlessly used as a component of the single-point-of-access cyber system.

The universal interactive operating system provides programming which provides and enables the processes and procedures which provide a standard system-wide interconnected interactive interface for use with a cyber device.

The universal interactive operating system provides programming which provides and enables the processes and procedures which provide for:

use of multiple lines of cyber communications;

use of multiple types of lines of cyber communications;

use of multiple providers of lines of cyber communications.

The universal interactive operating system provides programming which provides and enables the processes and procedures which require and provide for all devices within the cyber communications network to exclude all from interacting with cyber interactions while the cyber interactions are being transferred through the cyber communications network.

The universal interactive operating system provides programming which provides and enables the processes and procedures which require and provide for each separate cyber interaction to exclusively use a separate line of cyber communications whereby no two cyber interactions may use the same line of cyber communications at the same time.

The universal interactive operating system provides programming which provides and enables the processes and procedures which require and provide for a sender's cyber interactions to move one way only through a cyber communications line and for the recipient's cyber interactions to move one way only through a separate cyber communications line.

The universal interactive operating system provides programming which provides and enables the processes and procedures which provide safe and secure cyber interactions from a cyber device which transfer to and through an input output device which is being used by an individual and to the individual's point of cyber access computer. Further, the universal interactive operating system provides and enables the programming which provides processes and procedures which provide safe and secure cyber interactions from an individual's point of cyber access computer, through an input output device that is being used by the individual, to a cyber device.

The universal interactive operating system provides programming which provides and enables the processes and procedures which route cyber interactions through the cyber communications network.

The universal interactive operating system provides programming which provides and enables the processes and procedures which provide for all operations of the universal interactive operating system's safe, secure, and full-featured transfer packet system.

The universal interactive operating system provides programming which provides and enables the processes and procedures which require and provide for the use of transfer packet labels. The transfer packet labels are used for the purposes of: security; identification; routing; communicating a sender's requirements or requests; or any other required or desired utility which can be provided by information from a transfer packet label.

The universal interactive operating system provides programming which provides and enables the processes and procedures which compare a transfer packet's label to the contents of the transfer packet.

The universal interactive operating system provides programming which provides and enables the processes and procedures which provide for safe and secure deletion of transfer packets which have packet contents that do not match the transfer packet's label.

The universal interactive operating system provides programming which provides and enables the processes and procedures which provide for safe and secure use of mobile or in-motion cyber devices such as a vehicle or a cyber telephone device.

The universal interactive operating system provides programming which provides and enables the processes and procedures which provide single-point-of-access cyber system addresses for mobile or in-motion cyber devices.

The universal interactive operating system provides programming which provides and enables the processes and procedures which provide for use of the cyber communications network by mobile or in-motion cyber devices.

The universal interactive operating system provides programming which provides and enables the processes and procedures which provide for the use of a GPS locating device either independently, or in conjunction with, a cyber device.

The universal interactive operating system provides programming which provides and enables the processes and procedures which provide menus, or any other perceptible output which provides an individual with knowledge of, and access to, cyber interactions with cyber activities or cyber content which can be used by the individual from the individual's current location within the single-point-of-access cyber system.

The universal interactive operating system provides programming which provides and enables the processes and procedures which provide for a voice recognition driven user interface.

The universal interactive operating system provides programming which provides and enables the processes and procedures which provide an individual with the ability to store, to access, to use, and to manage file-based cyber assets and file based cyber resources.

The universal interactive operating system provides programming which provides and enables the processes and procedures which provide an individual with the ability to store, to access, to use, and to manage a lifelong collection of the individual's file-based cyber assets.

The universal interactive operating system provides programming which provides and enables the processes and procedures which provide an individual with a safe, secure location for storage, for access, for use, and for management of a lifelong collection of the individual's file-based cyber assets.

The universal interactive operating system provides programming which provides and enables the processes and procedures which provide a history of an individual's cyber activities as well as a history of the individual's device-based cyber asset's cyber activities.

The universal interactive operating system provides programming which provides and enables the processes and procedures which use a combination of one or more virtual projectors, one or more virtual projection display screens, and one or more virtual recorders or capture devices to converge a plurality of sources of image-based cyber content into one or more converged sources of interactive image-based cyber content.

The universal interactive operating system provides programming which provides and enables the processes and procedures which use a combination of one or more virtual projectors, one or more virtual projection display screens, and one or more virtual recorders or capture devices to alter any possible aspect of image-based cyber content in any possible way.

The universal interactive operating system provides programming which provides and enables the universal interactive operating system set of standard cyber processes and standard cyber procedures for use, management, and alteration of image-based cyber content.

The universal interactive operating system provides programming which provides and enables the processes and procedures which provide for creation and use of frames and scrolls formatted image-based cyber content.

The universal interactive operating system provides programming which provides and enables the processes and procedures which provide for frames and scrolls formatted image-based cyber content to use the total pixel width by total pixel height size of a targeted image output device to determine the total pixel width by a total pixel height size of an image which is to be transferred to the image output device.

The universal interactive operating system enables image-based cyber content which has both a total pixel width and a total pixel height which are smaller than or equal to the pixel width and the pixel height of the targeted image display device. Such content is considered to be a cyber image in frame format as shown in FIGS. 18B. and 18C.

The universal interactive operating system enables image-based cyber content which has a total pixel width which is greater than the pixel width of the targeted image display device or a total pixel height which is greater than that of the pixel height of the targeted image display device. Such content is considered to be a scroll formatted cyber image as shown in FIGS. 18E. and 18G.

The frames and scrolls format for image-based cyber content provides an individual with the ability to scroll through a scroll formatted cyber image so that an entire scroll formatted cyber image may be displayed by an image output device.

Further, the frames and scrolls format for image-based cyber content uses a pixel width by pixel height grid to identify the point on a frames or scrolls formatted cyber image where an input interaction was made by an individual as shown in FIGS. 16C. and 16F.

The universal interactive operating system provides programming which provides and enables the processes and procedures which provide for all aspects of operations and use of a safe, secure, and full-featured cyber license system.

In the single-point-of-access cyber system license system which is enabled by the universal interactive operating system a licensee is required to provide the licensor with:

the licensee's single-point-of-access cyber system identification;

the licensee's single-point-of-access cyber system address;

the identification of the licensed cyber resource; and

the rights the licensee has to the licensed cyber resource.

The universal interactive operating system provides programming which provides and enables the processes and procedures which provide for all aspects of operations and use of a safe, secure, and full-featured cyber mail system.

The universal interactive operating system provides programming which provides and enables the processes and procedures which provide for all aspects of operations and use of a safe, secure, and full-featured cyber message and cyber alert system.

The universal interactive operating system provides programming which provides and enables the processes and procedures which provide for all aspects of operations and use of a safe, secure, and full-featured cyber web site system.

The universal interactive operating system provides programming which provides and enables the processes and procedures which provide a sender with the option to receive a cyber acknowledgement of the recipient's receipt of a cyber interaction.

The universal interactive operating system provides programming which provides and enables the processes and procedures which provide system generated cyber messages when cyber activities do not execute properly.

The universal interactive operating system provides programming which provides and enables the processes and procedures which provide an individual with the ability to send to others system-generated cyber messages or system-generated cyber alerts based on any parameter the individual designates.

The universal interactive operating system provides programming which provides and enables the processes and procedures which provide safe, secure, and private interaction between any health care related cyber device or any cyber health care related cyber resource which is being used or relied upon by the individual, the individual's private computer, or the individual's point of cyber access computer.

The universal interactive operating system provides programming which provides and enables the processes and procedures which provide job management for the universal interactive operating system and task management for the universal interactive operating system.

The universal interactive operating system provides programming which provides and enables the processes and procedures which provide management for cyber devices which use the universal interactive operating system.

### Cyber Communications Network

The purpose of the cyber communications network 300 is to safely, securely, and efficiently transfer properly formatted and properly identified transfer packets from a properly identified sender to a properly identified recipient.

Transfer packets are the only single-point-of-access cyber system vehicles which are used to move cyber interactions from a sender to a recipient.

The single-point-of-access cyber system uses many unique transfer packet formats. The different and unique transfer packet formats are used for different types of cyber activities as well as for cyber activities which are for different purposes.

A point of cyber access computer uses differences in transfer packet formats to aid in providing security for all inbound cyber activities. The point of cyber access computer also uses differences in transfer packet formats to aid in the proper routing of cyber activities and cyber interactions.

The packet portion of a transfer packet contains all, or a part of, a sender's cyber interaction.

A sender's cyber interaction may require one or more transfer packets. A cyber interaction which requires more than one transfer packet has transfer packets which are identified as being a specific sequential part of a specific group of transfer packets.

Each transfer packet, at a minimum, has a label which provides:
the single-point-of-access cyber system address of the recipient's point of cyber access computer;
the recipient's single-point-of-access cyber system identification;
the sender's single-point-of-access cyber system identification;
verification of the sender's identity;
the single-point-of-access cyber system identification of the sender's point of cyber access computer;
the single-point-of-access cyber system address of the sender's point of cyber access computer;
verification of the identity of the sender's point of cyber access computer;
information about the contents of the transfer packet regarding if the transfer packet is one in a connected series of transfer packets that together, in proper sequence, make up one single cyber interaction from a sender;
information about the contents of a transfer packet which aid the recipient in determining if the sender's cyber interaction conforms with the recipient's requirements or preferences for privacy and the recipient's requirements or preferences for cyber interaction content;
history of every cyber interaction that the transfer packet has with a single-point-of-access cyber system cyber device.

A transfer packet label can include any information about the sender or any information about the contents of the transfer packet which was required or desired by the sender or the recipient of the cyber transfer packet.

Recipients of transfer packets can require that transfer packets include additional label information which can include any information about the sender or about the contents of the transfer packet which may aid the recipient in determining if the sender's cyber interaction will be allowed to gain access to the recipient's point of cyber access computer.

An example of a recipient's requirements for additional transfer packet label information about the sender or about the contents of a transfer packet would occur if a recipient required all senders to identify the sender as a business. The recipient may further require cyber interactions from a business to identify if the business was making an unsolicited marketing cyber interaction. In such case the recipient has the ability to exclude all unsolicited businesses marketing cyber interactions from gaining access to the recipient's point of cyber access computer.

The cyber communications network requires that each individual be properly identified prior to each step the individual's cyber interactions take through the cyber communications network. Further, the cyber communications network requires that each cyber device be properly identified prior to each step the cyber device's cyber interactions take through the cyber communications network. Cyber interactions from improperly identified individuals or improperly identified cyber devices cannot be processed by the cyber communications network.

The cyber devices which make up the cyber communications network do not have the ability to make changes to transfer packet labels or the ability to gain access to the contents of transfer packets.

A recipient has the ability to keep a complete history of transfer packet label information from any or all of the inbound cyber interactions which are received by the recipient. The recipient also has the ability to keep a history of transfer packet label information from any or all inbound cyber interactions which are denied access to the recipient's point of cyber access computer.

Communications between the devices within the cyber communications network can use wire, or optical fiber, or radio frequency, or any other means which provides adequate utility, or any combination thereof. When radio frequency is used for cyber communications, the single-point-of-access cyber system requires the use of encryption, or any other cyber security process which makes the contents of a transfer packet useless to all but the sender and the recipient.

The devices in the cyber communications network, the input output devices, the point of cyber access computers, and remote device-based cyber assets are required to provide security-based administrative cyber interactions between single-point-of-access cyber system cyber devices as an integral part of a corresponding cyber interaction which is being transferred between the same two single-point-of-access cyber system cyber devices. This process prevents intruders from interacting with transfer packets and the operations of the cyber communications network.

The devices in the cyber communications network provide a history of cyber activities and cyber interactions involving devices in the cyber communications network.

The device within the cyber communications network which comes in first contact with cyber interactions from an individual's point of cyber access computer is required to establish the identity of the individual's point of cyber access computer prior to the transfer of the individual's cyber interaction. The devices within the cyber communications network which come in first contact with the individual's point of cyber access computer can use any safe and secure process or method to establish the identity of the individual's point of cyber access computer.

After having properly established the identity of an individual's point of cyber access computer, the device within the cyber communications network which comes in first contact with cyber interactions from the individual is required to provide verification of the identity of the individual's point of cyber access computer prior to each step the individual's cyber interactions take through the single-point-of-access cyber system.

### Input Output Device

The purpose of the input output device 100 in the disclosed single-point-of-access cyber system is to:
send input from an individual using the input output device through the cyber communications network to the individual's point of cyber access computer;
receive output for the individual which was sent from the individual's point of cyber access computer through the cyber communications network to the input output device which is being used by the individual;
provide output which provides the individual with the ability to perceive the cyber interaction which was sent to the input output device through the cyber communications network from the individual's point of cyber access computer.

The input output device 100 uses the cyber communications network 300 to provide cyber interconnection for cyber interactions between the individual using an input output device and the individual's point of cyber access computer 200.

The input output device 100 uses an operating system which provides functional and operational programming for all of the functions of the input output device.

One type of input output device is a non-computer-based input output device 100 which has limited processing capabilities. A non-computer-based input output device only has those capabilities which are required to process input output device operational functions.

As a part of its operations, one type of input output device 100 has the ability to store its operating system as well as store cyber interactions which are required to be stored.

An input output device 100 may also be a cyber telephone device. When an input output device is also a cyber telephone device an individual's point of cyber access computer 200 can initiate cyber telephone communication cyber interactions with the individual at the individual's input output/cyber telephone device. Otherwise, the individual would initiate the process which provides remote cyber interactions between an individual using an input output device and the individual's point of cyber access computer 200.

Cyber interaction from an individual to the individual's point of cyber access computer 200 must originate from the input output device 100. The input output device 100 can provide the individual's point of cyber access computer 200 with information which allows the individual's point of cyber access computer 200 to establish the individual's identity. As previously indicated, proper identification of the individual prior to further cyber interactions with the individual is an essential tenet of the present invention.

Sending a cyber interaction from an individual using the input output device to the individual's point of cyber access computer requires the individual use properly formatted transfer packets. The properly formatted transfer packets are addressed to the individual as the recipient. The address contains the individual's single-point-of-access cyber system identification as well as the single-point-of-access cyber system address and the identification of the individual's point of cyber access computer.

Sending a cyber interaction from the individual's point of cyber access computer to an input output device which is being used by the individual requires that the individual's point of cyber access computer use the point of cyber access computer to send input output device transfer packets. The input output device transfer packets are addressed to the single-point-of-access cyber system identification and address of the input output device which is being used by the individual.

Upon first contact with the individual's point of cyber access computer, the individual's cyber interaction's request for access will be routed to the processes and procedures for granting the individual's cyber interactions access to the individual's point of cyber access computer.

Following an individual's request for the individual's cyber interaction to gain access to the individual's point of cyber access computer will be the execution of the individual's point of cyber access computer's process for establishing the identity of the individual. The cyber interactions from the individual who is using the input output device will only be granted access to the individual's point of cyber access computer after the individual's point of cyber access computer establishes the individual's identity.

An individual's point of cyber access computer, working in conjunction with the input output device which is being used by the individual, can use facial recognition, or voice recognition, or a password, or retinal scan, or a token, or any other suitable method of identification known to those of ordinary skill in the art, or any combination thereof received from the individual who is using the input output device to remotely establish the individual's identity.

Once cyber interactions from the individual gain access to the individual's point of cyber access computer, the cyber interactions from the individual will be routed to the individual's private computer. It is at the individual's private computer where the individual, through the individual's interactions with the input output device, has operational and administrative access to the individual's private computer, the individual's point of cyber access computer, the individual's public computer, the individual's cyber assets, the individual's cyber resources, and the individual's cyber telephone system.

Only cyber interactions from the individual can gain access to the individual's private computer 230. All cyber interactions from others are excluded from access to the individual's private computer.

Once the individual through the individual's interactions with the input output device has gained access to the individual's private computer 230, the individual is provided with options for further cyber interactions.

An individual using the input output device 100 sends cyber interactions through the cyber communications network to the individual's private computer 230. In turn, the individual's private computer 230 processes the individual's cyber interaction. The cyber interaction to be processed by the individual's private computer 230 can include any cyber activity which is available for use by the individual through the individual's point of cyber access computer 200, the individual's public computer 260, the individual's cyber assets, the individual's cyber resources, or the individual's cyber telephone system.

Cyber interactions with cyber activities, cyber interactions with cyber devices, and cyber interactions with cyber content which is available for use by the individual through the individual's private computer 230 will include: the individual's computer programs and applications; the individual's cyber telephone system; the individual's cyber asset manager; the individual's home automation system and its resources; the individual's vehicle; the individual's owned copies of cyber television, cyber video entertainment, and cyber music; the individual's cyber assets including cyber activity history, personal financial information, personal health information, photographs, or any other cyber activities or cyber devices or cyber content; and, access to the cyber resources of others which are available for the individual's use including books, magazines, newspapers, libraries, the cyber educational system, cyber services, the cyber health system, or any other cyber resource.

As a result of an individual's cyber interactions, the individual's private computer 230, or the individual's point of cyber access computer 200, or the individual's private computer 230 can respond to the individual by sending cyber interactions through the cyber communications network to the input output device 100 which is being used by the individual.

As an example, an individual can be typing on a keyboard which appears on the screen of the input output device while looking at the image on the image display screen of the input output device. When the individual inputs the letter “k” to the keyboard appearing on the screen of the input output device 100, and the individual communicates the individual's input of the letter “k” to the individual's remote point of cyber access computer 200, the individual's point of cyber access computer 200 will, in turn, respond to the input output device 100 which the individual is using. This response will provide an image which represents the changes to the prior image which were the results of the individual's prior cyber interactions.

Another example would be that the individual at the input output device 100 interacts with an image on the display screen of the input output device 100. The image appearing on the screen of the input output device provides the individual with choices for cyber interactions which are for labeled or otherwise identified purposes. The individual interacts with the image appearing on the display screen of the input output device 100, and the individual communicates the interaction to the individual's remote point of cyber access computer 200. The individual's point of cyber access computer 200 in turn processes the individual's cyber interaction and responds by providing the input output device 100 which the individual is using with a new image and associated links. The new image and associated links are the result of the individual's point of cyber access computer's processing of the individual's prior cyber interaction.

Yet another example would be that instead of a physical interaction with the display screen on the input output device, the individual speaks certain words, such as the instructions to open the garage door, into the input output device 100. The input output device 100 communicates the individual's voice command cyber interaction to the individual's point of cyber access computer 200. In turn the individual's point of cyber access computer 200 operates the individual's garage door opener. The individual's point of cyber access computer 200 may or may not notify the individual at the input output device depending on the previously determined and communicated preferences of the individual.

An individual's point of cyber access computer 200 has the ability to alter the functional and operational settings of the input output device 100 which is being used by the individual.

One possible result of an individual's cyber interactions with the individual's point of cyber access computer 200 can be that the individual's point of cyber access computer 200 responds in part or in whole to the individual's cyber interactions by automatically providing cyber interactions which alter both the functional and the operational settings of the input output device 100 which is being used by the individual.

Alterations to the functional and operational settings of the input output device 100 can be requested by the input output device 100, or by the individual through the individual's interactions with the input output device 100, or by the individual's point of cyber access computer 200, or by any cyber device, or by any cyber file.

The input output device 100 has the ability to return to predetermined functional and operational settings upon request, or upon completion of a cyber interaction which requested or required the altered functional and operational settings for the input output device.

An individual's point of cyber access computer 200 and the input output device 100 can each establish an interconnection with the cyber communications network. This cyber communications network interconnection uses an interconnection ranging from a momentary single line cyber communications network interconnection to continuous multiple line cyber communications network interconnections.

Cyber interaction between the input output device 100 and the individual's point of cyber access computer 200 which are transferred using the cyber communications network can simultaneously include one or more instances of cyber interactions between:
the individual's cyber assets and the individual's cyber asset manager;
the individual using the input output device 100 and the individual's point of cyber access computer 200;
a cyber resource and the individual's public computer 260;
the individual's private computer 230 and the individual at the input output device 100;
the individual's point of cyber access computer 200 and a cyber device;
the individual's private computer 230 and a cyber asset;
the individual's public computer 260 and a cyber resource.

The input output device 100 can be used as a cyber communications network link between device-based cyber assets or device-based cyber resources and an individual's point of cyber access computer 200.

The input output device 100 can use one or more lines of cyber communication. These lines of cyber communication can be between an input output device 100 and an individual's point of cyber access computer 200, or between an input output device 100 and any device-based cyber asset or cyber resource.

The input output device 100 is limited to processing only functional and operational programming. Therefore, the input output device 100 only runs the operating system programs which are resident at the input output device. An individual's private computer 230 provides processing, management, and support for the individual's computer programs and computer applications.

All cyber interaction from an individual's point of cyber access computer 200 to the input output device 100 the individual is using are to be completely processed and made ready for use by the input output prior to being sent through the cyber communications network.

The input output device 100 will, upon first cyber interaction with an individual's point of cyber access computer 200, provide the individual's point of cyber access computer 200 with information about the display screen size, the type, and the resolution of the input output device's display screen, as well as information about the operational capabilities and the operational settings of the input output device 100.

An input output device's components may include:
one single-point-of-access cyber system identification;
one single-point-of-access cyber system address;
one or more devices which provide operations for cyber communications over a cyber communications network;
interconnecting circuits;
one or more sources of power;
a protective housing;
and may also include one or more of the following:
an image display;
an audio output;
a camera;
a microphone;
a manual input device;
a cyber storage device;
an auxiliary input for interaction with other cyber devices;
an auxiliary output for interaction with other cyber devices.

The universal interactive operating system provides the needed programming to provide the input output device 100 with the ability to be used as a single-point-of-access cyber system input output device.

The universal interactive operating system provides the needed programming which provides for the interoperable use of the input output device 100 as an input output device 100 which has cyber interactions with cyber devices which do not use the universal interactive operating system.

The universal interactive operating system provides the needed programming which provides an individual with the ability to alter the operational configuration of the input output device 100 on a temporary or permanent basis.

The universal interactive operating system provides the needed programming which provides an input output device's single-point-of-access cyber system identification to the first device in the cyber communications network with which the input output device 100 has cyber interactions.

The universal interactive operating system provides the needed programming to the input output device which provides the input output device with the ability to provide all necessary cyber communications functions including use of properly formatted transfer packets for cyber interactions with any type of cyber devices.

The input output device 100 can be an integral part of the individual's point of cyber access computer 200; or, the input output device 100 can be directly connected to a point of cyber access computer 200; or, the input output device 100 can be a separate remote cyber device which communicates with an individual's point of cyber access computer 200 through use of the cyber communications network 300.

Communication between the input output device 100 and the individual's point of cyber access computer 200 can use radio frequency, fiber optic, wire, or any other suitable method for communications known to those of ordinary skill in the art, or any combination thereof.

The remote version of the input output device 100 provides an individual with the highest level of functional utility.

The input output device 100 can have cyber interactions with any cyber device which is capable of having cyber interactions with the input output device.

The input output device 100 may include one or more of the following sources for receiving input: a camera; a microphone; a keyboard; a pointing device; a touch or multi-touch display screen; a digital tablet; a sensor of any type; an input device of any type; a media reader; a stored information link; a GPS global position locating device; interconnections for other input devices; and any other sources of input known to those of ordinary skill in the art.

The input output device 100 may include one or more of the following ways of providing output: an image display device; an audio output device; a tactile output device; interconnections for other output devices; or any other possible output known to those of ordinary skill in the art.

The size of the input output device's image display can range from the smallest useable image display size to the largest image display size available.

The input output device 100 also includes a remote and a local connection for cyber interactions with an individual's point of cyber access computer.

Each input output device has a unique single-point-of-access cyber system identification and a mobile or stationary single-point-of-access cyber system address.

Any individual can use any input output device for cyber interactions with the individual's remote point of cyber access computer. Input output devices need not be user-specific. Input output devices may also be cyber telephone devices.

Computers such as those incorporated into cell phones, laptop computers, or desktop computers can also be used as single-point-of-access cyber system input output devices. These types of input output devices also have the ability to provide additional features and functions to the individual using the input output device.

The individual requires the use of the input output device 100 for cyber interactions with the individual's remote point of cyber access computer 200. The input output device 100 can be configured with two 8.5″×11″ multi-touch, digital tablet image display screens which are hinged together like a book in portrait format as shown in FIG. 16B. as used in the preferred embodiment. The illustrated input output device 901 shown in the array of images appearing in FIG. 16A.-F. makes an excellent, light, and manageable cyber book, or an input output device which can be used to review cyber-based content of any kind. The input output device shown in the array of images in FIG. 16A.-F. is not a computer. Rather, the input output device shown in the array of images in FIG. 16A.-F. is a remote input output device which is used for cyber interactions with an individual's point of cyber access computer or for cyber interactions with other cyber devices.

As shown in FIG. 16A. and FIG. 16B., if the individual takes the input output device 901 which the individual is holding in book configuration and the individual places the input output device on a table where it is oriented as, and can be used as, an open laptop computer, then, through use of a cyber communications network interconnection with the individual's point of cyber access computer, this input output device may become a remote terminal for cyber interactions with the individual's point of cyber access computer.

The multi-touch tablet-enabled image display screens on the illustrated input output device can each be used as keyboards or as a tablet for drawing, or handwritten notes, or marking of content.

Both of the image display screens on the illustrated input output device may also be arranged side-by-side to form one larger image display screen.

With a 180-degree flip and a fold-over of one of the image display screens of the input output device as shown in FIG. 16D. and FIG. 16E., the input output device can be transformed into a single-screen digital pad, or a digital tablet, or an interactive single screen image display as shown in FIG. 16F.

As shown in FIG. 16D., the input output device may include a camera, a microphone, and one or more speakers, partly to provide for multimedia functions and partly to provide information which can be used to provide the individual's point of cyber access computer with information which establishes the individual's identity.

The previously described remote input output device may well be a commonly used mid-sized portable input output device. An input output device such as a non-computer-based i-Phone-sized input output device puts interpersonal cyber communications as well as all of the capabilities of an individual's point of cyber access computer in the palm of the individual's hand.

Televisions, telephones, and other devices which provide audio/visual output can easily be adapted by a person of ordinary skill in the art for use as an input output device which can be used with the disclosed single-point-of-access cyber system.

The input output device 100 can be configured to provide additional functions beyond that of a basic input output device. These additional functions can be used to provide for the needs of a disabled individual, or for integration of the input output device into a special or single-purpose cyber system, or for any other purpose.

### Cyber Communications Network Between an Input Output Device and a Point of Cyber Access Computer

The purpose of the part of the cyber communications network 300 which is used between the input output device 100 and the individual's point of cyber access computer 200 is to safely and securely transfer properly formatted and properly identified transfer packets between the input output device 100 and the individual's point of cyber access computer 200.

There are unique transfer packet formats for:
cyber interactions from an individual's point of cyber access computer 200 to and through the cyber communications network 300 and to the individual who is using the input output device 100;
cyber interactions from an individual using the input output device 100 to and through the cyber communications network 300 and to the individual's point of cyber access computer 200;
cyber interactions from an individual's cyber assets to and through the input output device 100 which is being used by an individual to and through the cyber communications network 300 and to the individual's point of cyber access computer 200;
cyber interactions from the cyber resources of others to and through the input output device 100 which is being used by an individual to and through the cyber communications network 300 and to the individual's point of cyber access computer 200;
cyber interactions from an individual's point of cyber access computer 200 to and through the cyber communications network 300, to and through an input output device 100 which is being used by the individual, and to a cyber asset or to a cyber resource.

Cyber interactions between the input output device 100 and the individual's point of cyber access computer 200 can use:

multiple lines of cyber communications;

multiple types of lines of cyber communications;

multiple sources of lines of cyber communications.

Cyber interactions which use the part of the cyber communications network 300 between the input output device 100 and the individual's point of cyber access computer 200 are required to be protected from use by others by the use of encryption or other cyber security measures known to those of ordinary skill in the art which provide adequate security. Encryption renders the content of a transfer packet useless to all but the sender and the recipient.

The part of the cyber communications network 300 uses one or more of the following for the transfer of transfer packets: radio frequency; fiber optics; wire; any other suitable transfer method, or any combination thereof.

The cyber devices, cyber processes, and cyber procedures which serve the part of the cyber communications network 300 between the input output device 100 and the individual's point of cyber access computer 200 provide for transfers of transfer packets which are free from intrusion and interference by others.

### Point of Cyber Access Computer

The purpose of the point of cyber access computer 200 is to provide an individual with one and only one, safe and secure, remotely accessible computer which provides this one individual with the individual's access to: computing capabilities; the individual's cyber assets; the individual's cyber telephone system; and cyber resources.

The single-point-of-access cyber system 10 provides a system architecture in which each individual who uses the single-point-of-access cyber system 10 has one and only one point where the individual gains access to cyber activities, to cyber telephone communications, to cyber assets, and to available cyber resources. Further, all others have only one point of cyber access where the others can interact with the individual for cyber telephone communications and for cyber interactions. The individual's only portal for cyber access is the individual's one and only point of cyber access computer 200.

As previously stated, the foundation for the single-point-of-access cyber system 10 is that:
each individual is required to be properly identified prior to each step the individual's cyber interactions take through the single-point-of-access cyber system 10; and
each cyber device is required to be properly identified prior to each step the cyber device's cyber interactions take through the single-point-of-access cyber system 10.

An individual who desires to use the disclosed single point of access cyber system 10 may use the remote input output device 100 for cyber interactions with the individual's point of cyber access computer 200. The input output device 100 is used to provide the individual's point of cyber access computer 200 with information which allows the individual's point of cyber access computer 200 to establish the individual's identity.

After an individual's identity has been established by the individual's point of cyber access computer 200, the individual is granted access to the individual's point of cyber access computer 200. Further, after the individual's identity has been established by the individual's point of cyber access computer 200, the individual's point of cyber access computer 200 provides verification of the individual's identity prior to each step the individual's cyber interactions take through the single-point-of-access cyber system 10.

An individual's point of cyber access computer is the only device in the single-point-of-access cyber system which has the ability to establish the individual's identity and to provide verification of the individual's identity.

The point of cyber access computer 200 includes a separate private computer 230 and a separate public computer 260. Therefore, the point of cyber access computer 200 is a combination of three separate computers.

Each individual who uses the single-point-of-access cyber system 10 must be properly identified. An individual's point of cyber access computer 200 exclusively establishes the individual's identity. After the individual's identity has been established, the individual can gain access to the individual's private computer 230. Once access is gained to the individual's private computer 230, the individual will have full operational access and administrative access to not only the individual's private computer 230, but to the individual's point of cyber access computer 200 and to the individual's public computer 260 as well.

The device architecture of the point of cyber access computer solves many of the significant problems with prior art cyber systems and computers. An individual's point of cyber access computer includes three separate computers:

the individual's point of cyber access computer;

the individual's separate private computer; and

the individual's separate public computer.

The individual's point of cyber access computer 200 provides security, access control, and internal routing for all of the individual's point of cyber access computer's cyber activities. The individual's point of cyber access computer 200 also provides interoperability processing and conversion as needed for inbound cyber activities, for outbound cyber activities, and for internal cyber activities.

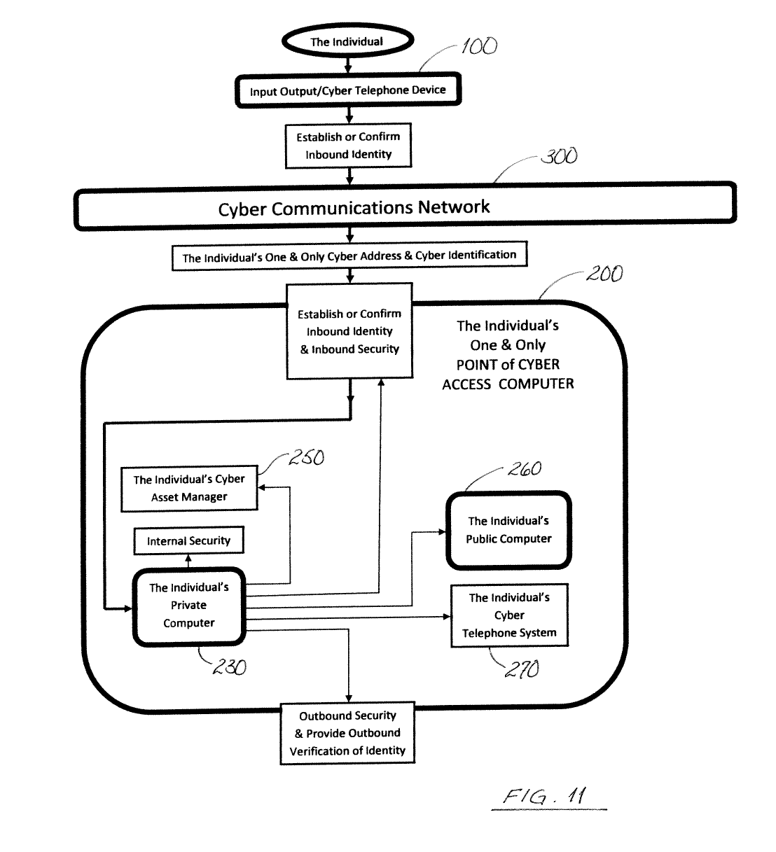

As shown in FIG. 11. an individual gains administrative control and operational control of the individual's point of cyber access computer 200 through the individual's private computer 230.

An individual has cyber interactions with the individual's private computer through the individual's use of the input output device 100. The individual's private computer 230 provides the individual with the ability to have cyber interactions with: the individual's point of cyber access computer 200; the individual's public computer 230; the individual's cyber telephone system 270; the individual's cyber assets; and available cyber resources. The individual's private computer 230 also provides the individual with the ability to have cyber interactions with others.

An individual's point of cyber access computer 200 must establish the individual's identity prior to providing the individual's cyber interactions access to the individual's point of cyber access computer 200. The individual's point of cyber access computer 200 must also establish the identity of the individual's device-based cyber assets prior to allowing the individual's device-based cyber assets' cyber interactions to gain access to the individual's point of cyber access computer 200.

Access to the individual's private computer 230 is only granted to the individual and to the individual's cyber assets. All others and the cyber devices of all others are excluded from gaining access to the individual's private computer.

An individual's public computer 260 is the only part of the individual's point of cyber access computer 200 where others can have cyber interactions with the individual or where others can gain access to the individual's cyber resources. The individual's cyber resources are only made available to others through the individual's public computer 260 and only with the permission of the individual.

An individual can choose to share all or any part of the individual's file-based cyber assets with specified others. The individual will make the individual's file-based cyber assets available to others by providing specified others with copies of the individual's cyber assets which are placed in the individual's public computer and made available to others through others' cyber interactions with the individual's public computer 260.

Cyber resources are an individual's file-based cyber assets which have been copied to the individual's public computer 260 for use by specified others.

It is an important security feature of the disclosed single-point-of-access cyber system that the single-point-of-access cyber system 10 requires the use of different and unique processes, procedures, formats, transfer packets, or codes for the operations of, and for cyber interactions with and between a point of cyber access computer 200 and the point of cyber access computer's private computer 230, and the point of cyber access computer's public computer 260.

The point of cyber access computer 200 pre-processes outbound cyber interactions to the input output device 100 so that the outbound cyber interactions can be transferred to, and used by, a recipient at the input output device 100 with no further processing of content required prior to the cyber interaction's receipt and use by the input output device 100.

The point of cyber access computer 200 provides an individual with the ability to provide others with the individual's requests or requirements for privacy as well as the individual's preferences or requirements for inbound cyber activities and for inbound cyber content.

The individual's point of cyber access computer 200 provides:
an individual with the one and only single point where the individual gains identified access to the single-point-of-access cyber system 10;
an individual with the only point where others can gain access to the individual for cyber interactions;
cyber security;
an individual with cyber interactions with the cyber communications network 300;
an individual with cyber interactions with at the input output device 100;
an individual with cyber interactions using a cyber telephone device;
routing of cyber activities;
an individual with access to the individual's private computer 230;
verification of the individual's identity at each step the individual's cyber interactions take through the single-point-of-access cyber system 10;
an individual with the ability to send outbound cyber interactions to the input output device or to remote cyber devices;
an individual with the ability to deny access to the individual's private computer 260 by cyber interactions from all others and the cyber devices of all others;
cyber interaction and security between the individual's point of cyber access computer 200 and the individual's private computer 230;
cyber interaction and security between the individual's point of cyber access computer 200 and the individual's public computer 260;
cyber interaction and security between the individual's private computer 230 and the individual's public computer 260;
processes and procedures which confirm the identity of others prior to allowing or denying each other access to the individual's point of cyber access computer 200;
an individual with the ability to provide specified others access to the individual's public computer 260 for specified purposes;
an individual with the ability to send outbound cyber interactions from the individual's public computer 260;
verification of the individual's identity when the individual is sending outbound cyber interactions from the individual's public computer 260;
verification of the individual's identity for the individual's interactions with the individual's device-based cyber assets;
processes and procedures which establish the identity of the individual's device-based cyber assets prior to allowing cyber interactions from the individual's device-based cyber assets to gain access to the individual's point of cyber access computer 200;
processes and procedures for device and file interoperability conversion to and from the single-point-of-access cyber system standard format;
an individual with a cyber telephone system which provides cyber telephone and cyber video telephone services.

As shown in FIG. 13. the individual's private computer 230 provides an individual with:
a safe, secure, and private cyber environment where no others may gain access;
computing capabilities;
computer programs;
computer applications;
a history of cyber activities;
storage, access, use, and management of the individual's file-based cyber assets which include but are not limited to the individual's personal information, the individual's health information, and the individual's financial information;
a cyber asset manager;
administrative control and operational control of the individual's device-based cyber assets including the individual's point of cyber access computer, the individual's private computer, the individual's public computer, the individual's cyber asset manager, and the individual's cyber telephone system;
cyber interaction with others;
cyber interactions with the cyber resources of others;
the ability to specify others who have access to the individual's public computer;
a system which allows the individual to share the individual's cyber assets with others by making copies of the individual's cyber assets available for specified others as a cyber resources;
a system which provides the individual with the ability to designate which cyber resources are available to a specified other through the individual's public computer;
a system which allows the individual to grant or to deny specified others access to the individual's public computer 260;
a system which allows the individual to grant or to deny specified others access to the individual's cyber resources.

As shown in FIG. 14. the individual's public computer 360 provides:
the only cyber portal where others can have cyber interactions with the individual;
cyber security;
the individual and others with computing;
the individual and others with computer programs;
the individual and others with computer applications;
the individual with the ability to send outbound cyber interactions in response to request from others;
the individual and others with an inbound cyber mail system;
the individual and others with an inbound cyber messaging system;
specified others with specified cyber resources;
storage, access, use, and management of the individual's file-based cyber resources;
the individual with the ability to grant or to deny specified others access to all or any part of the individual's public computer 260;
the individual with the ability to grant or deny specified others access to all or any part of the individual's cyber resources.

### Cyber Telephone System

A cyber telephone system can be a component of a point of cyber access computer.

A cyber telephone system provides services for cyber telephone and cyber video telephone communications. The cyber telephone system can also send device-based automated cyber telephone communications to others.

An individual typically initiates all outbound cyber telephone communications through the individual's private computer 230.

An individual has the ability to grant or to deny access to the individual's cyber telephone system by cyber telephone communication cyber interactions from others and from the cyber devices of others.

An individual can use transfer packet label information from an inbound cyber telephone communication cyber interaction to determine if the individual grants or denies access to the individual's cyber telephone system by the inbound cyber telephone communication cyber interaction.

An individual may further grant or deny access to all, or any part of the services of the individual's cyber telephone system by cyber telephone communication cyber interactions from specified others.

An individual's cyber telephone system provides:
cyber security;
the individual with the ability to grant or deny access to all or any part of the services of the individual's cyber telephone system by cyber telephone communication cyber interaction from others and from the cyber devices of others;
for routing of inbound cyber telephone communication cyber interactions or cyber alerts to a cyber telephone device at or near the person of the recipient;
a message-taking system;
for routing of cyber telephone communication cyber interactions to the individual's cyber telephone system's message taking system;
a message for the sender of an inbound cyber telephone communication cyber interaction;
the individual with the ability to re-direct inbound cyber telephone communication cyber interactions to different recipients or different cyber devices;
a history of cyber telephone system cyber activities.

An individual using an input output device, after having gained access to the individual's private computer, has complete operational control, administrative control, and access control of the individual's cyber telephone system.

An individual has the ability to simultaneously interact with the individual's cyber telephone system, the individual's point of cyber access computer, the individual's private computer, the individual's personal computer, and the individual's device-based cyber assets.

The programming, processes, and procedures of the universal interactive operating system provide for complete security for cyber telephone communication cyber interactions which are transferred from the individual's cyber telephone system to the individual's private computer or to the individual's public computer.

### Cyber Communications Network Between a Sender's Point of Cyber Access Computer and a Recipient's Point of Cyber Access Computer

The purpose of the part of the cyber communications network 300 which is used between a sender's point of cyber access computer and a recipient's point of cyber access computer is to safely and securely transfer properly formatted and properly identified transfer packets between a sender's point of cyber access computer and a recipient's point of cyber access computer.

A sender's cyber interaction which is to be directed to a recipient originates with the sender's cyber interactions with an input output device. The cyber interaction from the sender's interactions with the input output device goes to and through the cyber communications network, to and through the sender's point of cyber access computer, to and through the cyber communications network 300, to and through the recipient's point of cyber access computer, and then to the public computer within the recipient's point of cyber access computer.

A sender's cyber interaction to a recipient can also come from the sender's public computer and go to and through the sender's point of cyber access in computer, to and through the cyber communications network, to and through the recipient's point of cyber access computer, and then to the recipient's public computer.

A sender's cyber interaction to a recipient can also come from the sender's point of cyber access computer and go to and through the cyber communications network, to and through the recipient's point of cyber access computer, and then to the recipient's public computer.

There are many unique transfer packet formats for cyber interactions from the sender's point of cyber access computer to the recipient's point of cyber access computer. The different and unique types of transfer packet formats used to identify different types of cyber activities provide a high level of security for both the sender and the recipient.

Cyber interactions between a sender's point of cyber access computer and a recipient's point of cyber access computer can use one or more:

lines of cyber communications;

types of lines of cyber communications;

sources of lines of cyber communications.

A sender is required to be properly identified prior to each step the sender's cyber interactions take through the cyber communications network 300.

Cyber interactions which use the part of the cyber communications network 300 between a sender's point of cyber access computer 200 and a recipient's point of cyber access computer 200, most especially cyber interactions which use radio frequency, are protected from use by others by the use of encryption or other suitable cyber security measures known to those of ordinary skill in the art. Encryption renders the content of the transfer packets useless to all but the sender and the recipient of the transfer packet.

The devices, processes, and procedures which serve the part of the cyber communications network which is used between a sender's point of cyber access computer and a recipient's point of cyber access computer provide for cyber communications network transfer of transfer packets which are free from intrusion or interference by others.

### An Individual's Cyber Asset Manager and the Individual's Device-Based Cyber Assets

An individual's device-based cyber assets include, but are not be limited to: video cameras; televisions; television programming access and selection devices; personal health monitors; personal health care devices; devices for identification of others; vehicles; cyber vaults; cyber file back-up and restore devices; GPS locating devices; home or business automation management devices (which could monitor, record, and have cyber interactions with lights, heating and cooling systems, locks, garage door openers, lawn sprinkler systems, security systems, water meter readings, automated pet doors, personal weather stations, and more); or any other device-based cyber assets or systems.

An individual may have one or more device-based cyber assets which are not an integral part of the individual's point of cyber access computer.

An individual's remote device-based cyber assets have cyber interactions with the individual using one or more cyber asset managers.

An individual's cyber asset manager provides safe and secure cyber interactions between either the individual or the individual's cyber asset manager and the individual's device-based cyber assets. The individual's cyber asset manager also provides the individual with safe and secure administrative control and operational control of the individual's remote device-based cyber assets.

An individual gains administrative control and operational control of the individual's cyber asset manager through the individual's private computer 230. No others can gain administrative control or operational control of the individual's cyber asset manager.

There is complete security for an individual's cyber interactions which are transferred from the individual's cyber asset manager to the individual's private computer.

An individual's point of cyber access computer 200 establishes the identity of the individual's device-based cyber assets prior to providing cyber interactions from the individual's device-based cyber assets with access to the individual's cyber asset manager.

An individual's device-based cyber assets establish the identity of the individual's point of cyber access computer 200 prior to the individual's device-based cyber assets' providing cyber interactions from the individual's point of cyber access computer with access to the individual's device-based cyber assets.

An individual's cyber asset manager can be located within the individual's point of cyber access computer. This configuration of the location of the individual's cyber asset manager can be used for interaction with the individual's remote device-based cyber assets which require low security cyber interactions.

An individual can have only one, or an additional, cyber asset manager which is located within the individual's private computer. This configuration of the location of the individual's cyber asset manager can be used for cyber interactions with the individual's remote device-based cyber assets which require the highest level of security and privacy.

For example, an individual's cyber asset manager can have cyber interactions with a cyber device on the person of the individual. The cyber device on the person of the individual monitors and reports on the individual's blood sugar level. The individual may also have a cyber insulin delivery system which is operated through cyber interactions with the individual's cyber asset manager. The individual would need to rely on the individual's cyber interactions with both of these cyber devices with the individual's life. The individual would need to use the highest level of security and privacy available for the cyber interactions with these two cyber devices, and therefore the individual would want to have cyber interactions with these remote device-based cyber assets through a private-computer-based cyber asset manager.

An individual's cyber asset manager and the same individual's remote device-based cyber assets interconnect using the resources of the cyber communications network.

An individual's cyber asset manager and the individual's device-based cyber assets use the universal interactive operating system for cyber operations and cyber interactions.

An individual's device-based cyber assets only interact with the individual. Others who wish to have cyber interactions with the individual's device-based cyber assets must request that the individual provide the requestor with a copy of the requested cyber interaction information. A copy of the requested cyber interaction information from the individual's device-based cyber asset is made available for the requestor through the requestor's cyber interaction with the individual's public computer 260.

An individual's cyber asset manager and the individual's device-based cyber assets each provide a history of cyber interactions and cyber activities.

### Cyber Communications Network Between an Individual's Cyber Asset Manager and the Individual's Remote Device-Based Cyber Assets

The purpose of the part of the cyber communications network which is used between an individual's cyber asset manager and the individual's remote device-based cyber assets is to safely and securely transfer properly formatted and properly identified transfer packets between the individual's cyber asset manager which is within the individual's point of cyber access computer and the individual's remote device-based cyber assets.

An individual's cyber asset manager's cyber interaction with one of the individual's remote device-based cyber assets comes from the individual's cyber asset manager, through the individual's private computer, to and through the individual's point of cyber access computer, to and through the cyber communications network, to the individual's remote device-based cyber asset.

An individual's remote device-based cyber asset's cyber interaction with the individual's cyber asset manager comes from the individual's remote device-based cyber asset, to and through the cyber communications network, to and through the individual's point of cyber access computer, to the individual's cyber asset manager, to and through the individual's private computer, and then to the individual's cyber asset manager.

There are many unique transfer packet formats for cyber interactions between an individual's cyber asset manager and the individual's remote device-based cyber assets. The different and unique transfer packet formats are used to identify cyber interactions between different types of cyber devices, and to identify cyber interactions for different functions or purposes.

Cyber interactions between an individual's cyber asset manager and the individual's remote device-based cyber assets can use:

one or more lines of cyber communications;

one or more types of lines of cyber communications;

one or more sources of lines of cyber communications.

An individual's device-based cyber assets can use a cyber telephone device which is being used by the individual, or an input output device which is being used by the individual as a cyber communications network link to or from the individual's point of cyber access computer.

An individual's cyber asset manager is required to be properly identified prior to each step that the individual's cyber asset manager's cyber interactions take through this part of the cyber communications network. Further, the individual's remote device-based cyber assets are required to be properly identified prior to each step the individual's remote device-based cyber assets' cyber interactions take through this part of the cyber communications network.

Cyber interactions which use the part of the cyber communications network which is used between an individual's cyber asset manager and the individual's remote device-based cyber assets, most especially those cyber interactions that use radio frequency, are protected from use by others by the use of encryption or other suitable cyber security measures.

The devices, processes, and procedures which control the operations of this part of the cyber communications network through their use of the programming, processes, and procedures which are a part of the universal interactive operating system provide for the safe and secure transfer of transfer packets which are free from intrusion or interference by others.

### Examples of Use of the Single-Point-Of-Access Cyber System

On election day in November every voter in the United States can, through use of an input output device, gain identified access to their point of cyber access computer. Thus every voter has the ability to safely, securely, and privately cast their vote in any, or in all, of the elections where the individual is eligible to cast a vote.

As an example, in an elementary school classroom, a student can use an input output device such as shown in FIG. 16 A.-F. which has two approximately 8″ by 11″ multi-touch, digital tablet enabled image display screens which are hinged together on one side like a book in portrait format can be used as shown in FIG. 16B. The student can turn the same input output device 90 degrees where it resembles and provides the functions of a laptop computer.

The input output device, through use of the cyber communications network, can have cyber interactions with the student's remotely located point of cyber access computer.

As shown in FIGS. 16C. and 16F., the student can use a stylus 907 in conjunction with the digital tablet feature of the input output device's display screens to write, to draw, or to interact with an image appearing on the display screen. The student can also use the multi-touch mode of the display screens for interaction with their point of cyber access computer. The student's display screen's multi-touch mode also provides the student with a touch screen keyboard. Further, the student can use the input output device's microphone or camera for input for cyber interaction with the student's point of cyber access computer. Also, the student may use any type of cyber input device which can interact with the student's input output device.

The student's point of cyber access computer provides the student with access to cyber educational materials from multiple sources such as a cyber library, or a cyber compendium of information, or the student's school district's cyber library.

The student's point of cyber access computer uses school district supplied computer programs, school district supplied computer applications, and school district supplied cyber educational materials.

The student uses an input output device to remotely access the student's point of cyber access computer so that the student may use the school district supplied cyber-based educational resources and materials for the class that the student is currently attending.

The student has full interactive access to all available cyber-based educational resources and materials.

The student can use a stylus 907 to either write a report or to work on math problems.

The student stores the student's schoolwork using the cyber resources of the student's point of cyber access computer.

The student submits finished school work to the student's teacher using the cyber mail functions of the single-point-of-access cyber system.

The student can also use the single-point-of-access cyber system for cyber telephone communication cyber interactions with the student's teacher during class by simply using the single-point-of-access cyber system's cyber video telephone functions for remote cyber interaction with the student's teacher from across the classroom.

The student's teacher, through use of school district supplied computer programs and computer applications, can access a copy of the image which is displayed on the student's input output device. Using the same school district supplied computer programs and computer applications, the student's teacher has the ability to have cyber interactions with the student by providing graphic input to the student which can be viewed by the student on the image display screen of the student's input output device.

All of the previously addressed school-related cyber activities do not require that cyber interconnection infrastructure be provided by the school district. Every cyber-based educational activity is performed using the single-point-of-access cyber system's cyber mail functions, cyber interaction functions, and cyber video telephone functions.

The school district can provide the student with cyber educational materials which the school district deems appropriate.

The school district can also provide the student with cyber educational materials which are appropriate for the student's abilities in any field of study. Further, the school district can supply the student with cyber educational materials which are formatted to be of most interest to the student and most suitable to the learning style of the student. Therefore, a school district which uses the educational resources made available through use of the single-point-of-access cyber system can, and will, make “no child left behind” an educational concept and challenge of the past.

It should also be noted that the student can use any input output device to remotely access the cyber-based educational resources made available to the student through the student's point of cyber access computer from anywhere the student is located.

In the context of an individual's health care, an individual has a health related examination by a health care provider, the health care provider is required to safely, securely, and privately:
maintain a record of the interaction between the health care provider and the individual for the lifetime of the individual;
provide the single-point-of-access cyber system health care registry with the individual's single-point-of-access cyber system identification, along with the health care providers single-point-of-access cyber system identification and the date of the health care related service;
provide the individual with a complete record of the individual's health care related interaction with the health care provider by sending a copy of the health care provider's record to the individual through the individual's public computer.

The individual can review the copy of the health care provider's record for the individual's health related examination for accuracy and then require the health care provider correct inaccuracies if needed.

The individual can choose to save all, or any part of, the health care provider's record of the individual's health related examination by transferring the copy of health care provider's record from the individual's public computer to the individual's private computer where the record or any part thereof can be saved as a part of the individual's safe, secure, and private files which contain the individual's personal health records.

The individual can also choose to delete the copy of the health care provider's record of the individual's health related examination.

If the individual happens to lose, or deletes, the copy of the health care provider's record of the individual's health related examination, the individual can contact the single-point-of-access cyber system health care registry and receive the needed information. The single-point-of-access cyber system health care registry provides information to the individual which only includes the health care provider's single-point-of-access cyber system identification and the date of the individual's health related examination. Using information provided by the single-point-of-access cyber system health care registry, the individual can request that the health care provider send the individual a copy of the health care provider's record of the individual's prior health related examination. The health care provider is required to provide a copy of the record of the individual's health related examination to the individual only, thereby providing the individual with complete privacy for single-point-of access cyber system-based health records.

The individual can, anonymously, or with the knowledge of others of the individual's identity, choose to share all or any part of the individual's health related information with specified others.

If a third party such as a health care insurance company was obligated to pay for any part of the individual's health related examination, the third party insurance company can require that the individual provide the third party insurance company with a cyber interaction which discloses or confirms any or all of the details about the health related services the individual received from the health care provider. This simple two-step process eliminated the opportunity for health care fraud.

The individual can safely, securely, and privately share all or any part of the individual's health information with health care providers The individual's shared health information will provide the health care provider with a tool to use to better provide appropriate health care services to the individual.

The individual can safely, securely, privately, and anonymously share all or any part of the individual's personal health information with scientists or researchers seeking improved health care outcomes. Quantum leaps forward may be made by scientists and researchers when anonymously donated reliable health information from large numbers of individuals are made available for research.

The individual can also choose to provide the individual's health information to an agency such as the United States Center for Disease Control and Prevention (CDC) so that the CDC can use the individual as one of many who are used to monitor a geographic area or a specific part of the population for targeted health related occurrences. The CDC can then monitor a sample of people to determine when and where there is an outbreak of flu or food borne illness, and when and where there is an occurrence of any other targeted health related issue.

The single-point-of-access cyber system's ability to allow an individual to safely, securely, privately, and anonymously share the individual's health information with others will provide public health entities with an informational tool which fills the public health entities state-of-the-public's-health informational need.

The single-point-of-access cyber system provides an all-inclusive world-wide database of health care information as well as area-appropriate definitions for the health care information that is contained within the database. This database is an ultimate informational tool for scientists and medical researchers to use to improve health care outcomes worldwide.

The single-point of access cyber system provides an individual with a safe, secure, and private process for cyber interactions with cyber health monitoring devices or cyber health care delivery devices which are on or near the person of the individual.

For example, an individual uses a cyber body function monitor on their person. The cyber body function monitor, using the resources of the single-point-of-access cyber system, has cyber interactions with the individual's point of cyber access computer. The individual's cyber body function monitor reports to the individual's point of cyber access computer that the individual has a blood sugar level which requires the individual's cyber insulin delivery system which is on the person of the individual to deliver a specified amount of insulin to the individual's bloodstream. The individual can require that the individual's permission is given prior to the delivery of insulin, or the individual can allow an automated delivery of insulin if the automated delivery does not exceed a pre-determined amount of insulin. The individual requires a dose of insulin which exceeds this pre-determined acceptable dose, so, the individual is required to approve of the indicated necessary dose of insulin before the indicated necessary dose of insulin is delivered.

The single-point-of-access cyber system's ability to safely, securely, and privately monitor and record information which is received from a cyber health monitoring device that is on or near the person of the individual provides an individual with intermittent or continuous reporting from cyber health related monitors of any type. Information from cyber health related monitors can be saved by the individual for use by the individual or for use by health care providers. Or, information from the individual's cyber health related monitors can be used by science and medicine to enable science and medicine to better understand the intricacies of the workings of a human body to provide improved health care outcomes worldwide.

In another example, an individual is driving towards the individual's residence. The individual inputs the voice command, “open the garage door,” to the individual's pocket-sized input output/cyber telephone device. The individual's point of cyber access computer receives the individual's voice recognition-based cyber interaction and in turn monitors the GPS locating device which is a part of the individual's input output/cyber telephone device so that the individual's point of cyber access computer may determine the optimum point in time to interact with the individual's garage door opener. The individual's point of cyber access computer interacts with the individual's garage door opener to open the individual's garage door when the individual and the individual's vehicle approach.

While the disclosed system has been defined in terms of its preferred and alternative embodiments, those of ordinary skill in the art will understand that numerous other embodiments and applications of the disclosed system will become apparent. Such other embodiments and applications shall be included within the scope and meaning of the appended claims.

What is claimed is:

1. A single-point-of-access cyber system comprised of:
programming and devices which are used for processing cyber activities;
programming and devices which provide an individual with a single point of cyber access;
an input output device which is used for cyber interactions between said individual at said input output device and said programming and devices which provide said individual with a single point of cyber access;
programming and devices which provide a cyber communications network;
programming and devices which provide for cyber activities among said individual, others, the cyber assets of said individual, and the cyber resources of said others.

2. The single-point-of-access cyber system as defined in claim 1 which further includes a system requirement wherein said individual is required to use a single exclusive device wherein said individual gains said individual's only identified access to cyber communications, to cyber activities, to said cyber assets of said individual, and to said cyber resources of said individual and said others.

3. The single-point-of-access cyber system as defined in claim 1 wherein each said individual who uses the single-point-of-access cyber system has only one unique, lifelong, single-point-of-access cyber system identification.

4. The single-point-of-access cyber system as defined in claim 1 wherein said single-point-of-access cyber system will interact with cyber devices, each of said cyber devices having a single-point-of-access cyber system address, and each of said cyber devices further having only one unique single-point-of-access cyber system identification.

5. The single-point-of-access cyber system as defined in claim 4 which further includes:
programming and devices which are used to establish the identity of each said cyber device and each said individual who uses the single-point-of-access cyber system;
programming and devices which are used to verify the identity of each said cyber device and each said individual who uses the single-point-of-access cyber system; and
programming and devices which are used to confirm the identity of each said cyber device and each said individual who uses the single-point-of-access cyber system.

6. The single-point-of-access cyber system as defined in claim 4 which further includes system requirements which require:
proper identification of each said individual prior to each step the cyber interactions of said individual take through the single-point-of-access cyber system; and
proper identification of each of said cyber device prior to each step the cyber interactions of said cyber device take through the single-point-of-access cyber system.

7. The single-point-of-access cyber system as defined in claim 1 which further includes an individual's point of cyber access computer.

8. The single-point-of-access cyber system as defined in claim 7 wherein said individual's point of cyber access computer further includes programming and devices which establish said individual's identity prior to providing said individual with access to said individual's point of cyber access computer.

9. The single-point-of-access cyber system as defined in claim 7 wherein said individual's point of cyber access computer further includes a separate private computer which is used for processing and support for said individual's private cyber activities as well as a separate public computer which is used for processing and support for said individual's public cyber activities, and
wherein each of said separate private computer and each said separate public computer can only be accessed through said individual's point of cyber access computer.

10. The single-point-of-access cyber system as defined in claim 9 which further includes programming and devices which provide said individual with safety, security, and privacy for said individual's cyber activities by providing separate processing and support for said individual's private cyber activities, as well as by providing separate and different processing and support for said individual's public cyber activities.

11. The single-point-of-access cyber system as defined in claim 7 wherein said individual's point of cyber access computer further includes programming and devices which provide said individual with the ability to store, to access, to use, and to manage a lifelong collection of said individual's file-based cyber assets and file-based cyber resources.

12. The single-point-of-access cyber system as defined in claim 10 wherein said individual's point of cyber access computer further includes:
programming and devices which provide for safe and secure cyber interactions between:
said individual's separate private computer and said individual's point of cyber access computer;
said individual's separate private computer and said individual's separate public computer;
either said individual's separate private computer or said individual's point of cyber access computer and said individual's device-based cyber assets.

13. The single-point-of-access cyber system as defined in claim 7 wherein said individual's point of cyber access computer further includes:
programming and devices which confirm the identity of each other prior to allowing cyber interactions from said other to gain access to said individual's point of cyber access computer;
further, said individual's point of cyber access computer includes programming and devices which confirm or establish the identity of each cyber device prior to allowing cyber interactions from said cyber device to gain access to said individual's point of cyber access computer.

14. The single-point-of-access cyber system as defined in claim 10 wherein said point of cyber access computer further includes programming and devices which exclude the cyber interactions of others as well as the cyber interactions of the cyber devices of others from gaining access to said individual's private computer.

15. The single-point-of-access cyber system as defined in claim 13 which further includes programming and devices which provide said individual with the ability to:
grant or deny access to all or part of an individual's cyber telephone system by cyber interactions from specified others;
grant or deny cyber access to all or part of said individual's public computer and said cyber resources contained within by interactions from specified others.

16. The single-point-of-access cyber system as defined in claim 7 wherein said individual's point of cyber access computer further includes programming and devices which provide for cyber interactions between said individual's point of cyber access computer and remote cyber devices.

17. The single-point-of-access cyber system as defined in claim 8 wherein said individual's point of cyber access computer, after having established the identity of said individual, and after having granted the cyber interactions of said individual access to said individual's point of cyber access computer, will provide verification of said individual's identity prior to each step said cyber interactions of said individual take through the single-point-of-access cyber system.

18. The single-point-of-access cyber system as defined in claim 1 which further includes a cyber communications network which includes cyber communications network devices,
wherein prior to further cyber interactions between said cyber communications network and said individual's point of cyber access computer, the single-point-of-access cyber system requires said cyber communications network to use the cyber device within said cyber communications network which engages in the first cyber interactions with said individual's point of cyber access computer to both confirm said individual's identity, and to establish the identity of said individual's point of cyber access computer.

19. The single-point-of-access cyber system as defined in claim 18 wherein after said cyber communications network's device has confirmed said individual's identity and has established the identity of said individual's point of cyber access computer, said device within said cyber communications network which has engaged in the first cyber interactions with said individual's point of cyber access computer will provide verification of the identity of said individual's point of cyber access computer prior to each step the cyber interactions of said individual take through the single-point-of-access cyber system.

20. The single-point-of-access cyber system as defined in claim 1 which further includes programming and devices which provide said individual with the ability to request or require that others provide said individual with varying levels of privacy as defined by said individual, for cyber activities between said individual and said others.

21. The single-point-of-access cyber system as defined in claim 1 which further includes a system requirement wherein prior to cyber content being sent to a recipient, said cyber content will be pre-processed so that said cyber content can be used by said recipient's input output device with no further processing required by said recipient's input output device.

22. The single-point-of-access cyber system as defined in claim 4 which further includes programming and devices which provide system-standard interface and interaction processes and procedures, said system-standard interface and interaction processes and procedures provide for interoperable use of any cyber device as a component of the single-point-of-access cyber system.

23. The single-point-of-access cyber system as defined in claim 1 which further includes programming and devices which minimize the number of operational processes and procedures which are used by others by providing and requiring system-wide use of single-point-of-access cyber system operational processes and procedures by others.

24. An input output device which provides an individual with the ability to remotely interact with said individual's point of cyber access computer, said input output device is comprised of:
programming and devices which are used to send cyber interactions from the individual to said individual's point of cyber access computer;
programming and devices which are used to receive cyber interactions from said individual's point of cyber access computer;
programming and devices which enable said individual to perceive output which is the result of the input output device receiving said cyber interactions from said individual's point of cyber access computer;
programming and devices which are used to interact with said individual's point of cyber access computer through the use of a cyber communications network.

25. The input output device as defined in claim 24 which further includes programming and devices which provide said individual's point of cyber access computer with information which provides said individual's point of cyber access computer with the ability to both establish the identity of said individual as well as establish the identity of the input output device which is being used by the individual.

26. The input output device as defined in claim 24 which further includes programming and devices which provide said individual with the ability to use the input output device for cyber interactions between said individual and said individual's point of cyber access computer.

27. The input output device as defined in claim 24 wherein said programming and devices which are used to both send cyber interactions from said individual to said individual's point of cyber access computer, and receive cyber interactions from said individual's point of cyber access computer, further includes a cyber telephone device.

28. The input output device as defined in claim 24 which further includes programming and devices which provide the input output device with the ability to interact with any compatible cyber device.

29. The input output device as defined in claim 24 which further includes programming and devices which provide for the use of the input output device as a cyber communications network link between said individual's point of cyber access computer and a remote cyber device.

30. Architecture for a single-point-of-access cyber system which defines both the components of the single-point-of-access cyber system and the interrelationship of the components of the single-point-of-access cyber system, said architecture for a single-point-of-access cyber system is comprised of:
a universal interactive operating system which provides programming which provides processes and procedures which provide a cyber environment which provides for the single-point-of-access cyber system architectural rules and requirements as well as the operational programming for single-point-of-access cyber system devices and components;
single-point-of-access cyber system architectural rules and requirements;
single-point-of-access cyber system structure including:
one or more point of cyber access computers;
one or more input output devices for an individual to use for cyber interaction between said individual and said one or more point of cyber access computers;
one or more cyber devices constructed and arranged for cyber interactions with said one or more point of cyber access computers;
a cyber communications network;
wherein said one or more point of cyber access computers, said one or more input output devices, and said one or more cyber devices operate within said cyber communications network using said universal interactive operating system.

31. Architecture for a single-point-of-access cyber system as defined in claim 30 which further includes programming and devices which provide both separate processing and support for said individual's private cyber activities as well as separate and different processing and support for said individual's public cyber activities.

32. Architecture for a single-point-of-access cyber system as defined in claim 30 wherein said one or more point of cyber access computers include said individual's point of cyber access computer, and
said individual's point of cyber access computer is a combination of three separate computers:
said individual's point of cyber access computer which is required to establish or confirm the identity of the sender of each cyber interaction prior to providing the sender's cyber interaction with access to said individual's point of cyber access computer;
said individual's private computer which can only be accessed through said individual's point of cyber access computer, and can only be accessed by cyber interactions from both said individual and said individual's device-based cyber assets; and
said individual's public computer which can be accessed by cyber interactions from others and can only be accessed through said individual's point of cyber access computer.

33. The single-point-of-access cyber system architecture as defined in claim 30 wherein said single-point-of-access cyber system architectural rules require the identification of each individual prior to each step the cyber interactions of said individual take through the single-point-of-access cyber system; further, single-point-of access cyber system architectural rules require the identification of each cyber device prior to each step the cyber interactions of said cyber device take through the single-point-of-access cyber system.

34. Architecture for a single-point-of-access cyber system as defined in claim 32 which further includes a cyber asset manager.

35. Architecture for a single-point-of-access cyber system as defined in claim 32 which further includes a cyber telephone system.

36. Architecture for a single-point-of-access cyber system as defined in claim 30 which further includes programming which provides system-standard interface and interaction processes and procedures, wherein said one or more cyber devices can be configured to be used as a part of the single-point-of-access cyber system by means of said one or more cyber devices' use of said system-standard interface and interaction processes and procedures.

37. Architecture for a single-point-of-access cyber system as defined in claim 30 wherein processes and procedures can be:
added to said single-point-of-access cyber system;
removed from said single-point-of-access cyber system;
arranged in any configuration as a part of said single-point-of-access cyber system.

38. Architecture for a single-point-of-access cyber system as defined in claim 30 wherein architectural components and cyber devices can be:
added to said single-point-of-access cyber system;
removed from said single-point-of-access cyber system;
arranged in any configuration as a part of said single-point-of-access cyber system.

39. Architecture for a single-point-of-access cyber system as defined in claim 30 which further includes single-point-of-access cyber system device architecture wherein components, processes, and procedures can be:
added to a cyber device;
removed from a cyber device;
arranged in any configuration as a part of a cyber device.

40. Architecture for a single-point-of-access cyber system as defined in claim 30 which further includes:
a single interconnected cyber system for use by said individual for said individual's cyber interactions and cyber activities;
a system-wide set of standard processes and procedures which provide for and require compliance with single point of access cyber system architectural rules and requirements;
a requirement that each cyber device and each individual who uses the single-point-of-access cyber system always be properly identified;
a single, remote, point of cyber access computer for said individual to exclusively use for single-point-of-access cyber system cyber communications, cyber interactions, and cyber activities;
programming and devices which provide said individual with remote access to cyber assets and cyber resources.

41. A universal interactive operating system for a single-point-of-access cyber system, said single-point-of-access cyber system, which is used by an individual, includes, a cyber communications network, file-based cyber assets, device-based cyber assets, file-based cyber resources, device-based cyber resources, one or more input output devices, and one or more remote point of cyber access computers; said universal interactive operating system is comprised of:
programming which provides the ability to identify each individual and each cyber device;
programming which requires each individual to be properly identified prior to each step the cyber interactions of said individual take through the single-point-of-access cyber system;
programming which requires each cyber device to be properly identified prior to each step the cyber interactions of said cyber device take through the single-point-of access cyber system;
programming which provides for the use of and the operations of a cyber communications network;
programming which provides for storage, access, use, and management of file-based cyber assets and file-based cyber resources;
programming which provides for the use of and the operations of device-based cyber assets and device-based cyber resources;
programming which provides security;
programming which provides for the use of and the operations of input output devices;
programming which provides for the use of and the operations of remote computers;
programming which maintains a history of cyber activities;
programming which provides an individual with control of said individual's single-point-of-access cyber system administrative settings;
programming which provides an individual with control of said individual's single-point-of-access cyber system operational settings;
programming which provides an individual with control of said individual's single-point-of-access cyber system access settings;
programming which provides said individual with the ability to request that others provide said individual with said individual's preferences for cyber interactions, for cyber content, and for privacy;
programming which provides for the use of and the operations of a cyber asset manager;
programming which provides for the use of and the operations of a cyber telephone system.

42. The universal interactive operating system as defined in claim 41 which further includes programming which provides and requires both separate processing and support for said individual's private cyber activities as well as separate and different processing and support for said individual's public cyber activities.

43. The universal interactive operating system as defined in claim 41 which further includes programming and devices which provide for interoperable use of cyber files and cyber devices which do not use the standard processes, procedures, and formats of the universal interactive operating system by providing processes and procedures which convert cyber activities, cyber content, and cyber interactions to and from the standard processes, procedures, and formats of the universal interactive operating system.

44. The universal interactive operating system as defined in claim 41 which further includes a frames and scrolls format for production of and use of interactive image-based cyber content.

45. The universal interactive operating system as defined in claim 41 which further includes programming and devices which require and provide for unique separate processes, procedures, protocols, codes, or formats to be used for both cyber activities and cyber interactions which are of different types or which are used for different purposes.

46. The universal interactive operating system as defined in claim 41 which further includes a cyber license system.

47. The universal interactive operating system as defined in claim 41 which further includes programming and devices which provide said individual with exclusive access to, and use of:
the administrative controls, the operational controls, and the access controls for:
said individual's point of cyber access computer;
said individual's private computer;
said individual's public computer;
said individual's cyber asset manager;
said individual's cyber telephone system;
said individual's cyber assets;
said cyber resources.

48. The universal interactive operating system as defined in claim 41 which further includes processes and procedures which use one or more virtual projectors in conjunction with one or more virtual projection display screens which receive the image output from said one or more virtual projectors, and one or more virtual recorders which record both the virtual images from said one or more virtual projection screens, and the virtual audio from said one or more virtual projectors for:
providing interoperability conversion of cyber content, cyber interactions, and cyber activities to or from said universal interactive operating system-standard format;
providing security;
altering cyber image size, altering cyber image resolution, or altering the visual presence of a cyber image;
interactive alteration of image-based cyber content;
converging two or more sources of image-based cyber content into one or more converged sources of interactive image-based cyber content.

49. The universal interactive operating system as defined in claim 41 wherein programming is provided which includes processes and procedures which provide a cyber environment wherein said individual can:
add architectural components to, add cyber components to, and add cyber devices to said single-point-of-access cyber system;
remove architectural components from, remove cyber components from, and remove cyber devices from said single-point-of-access cyber system; and
alter the configuration of the architectural components of, alter the configuration of the cyber components of, and alter the configuration of the cyber devices of said single-point-of-access cyber system.

50. The universal interactive operating system as defined in claim 41 wherein programming is provided which includes processes and procedures which provide a cyber environment wherein said individual can:
add processes and procedures to said single-point-of-access cyber system;
remove processes and procedures from said single-point-of-access cyber system;
alter the configuration of the processes and the procedures of said single-point-of-access cyber system.

51. The universal interactive operating system as defined in claim 41 wherein programming is provided which includes processes and procedures which provide a cyber environment wherein said individual can:
add components, add processes, and add procedures to a cyber device;
remove components, remove processes, and remove procedures from a cyber device;
alter the configuration of the components, alter the configuration of the processes, and alter the configuration of the procedures of a cyber device.

52. A point of cyber access computer which provides an individual with access to computing capabilities, with access to cyber interactions, with access to cyber communications, with access to the individual's cyber assets, and with access to the cyber resources of others, said point of cyber access computer is comprised of:
programming and devices which are used for processing cyber activities;
programming and devices which are used for providing security;
programming and devices which are used for establishing, verifying, and confirming identity;
programming and devices which provide for cyber interactions between said individual at an input output device and said individual's point of cyber access computer;
programming and devices which provide for cyber interactions with others;
programming and devices which provide for cyber interactions with cyber devices;
programming and devices which provide for storing, accessing, using, and managing cyber files;
programming and devices which provide for the transfer of cyber communications, cyber interactions, and cyber activities over a cyber communications network.

53. The point of cyber access computer as defined in claim 52 which further includes a cyber telephone system, said cyber telephone system provides processing and management of, as well as security for, an individual's cyber telephone services and cyber video telephone services.

54. The point of cyber access computer as defined in claim 52 which further includes a cyber asset manager, said cyber asset manager provides processing, and management of, as well as security for, cyber interactions between said individual's cyber asset manager and said individual's point of cyber access computer, as well as cyber interactions between said individual's cyber asset manager and said individual's device-based cyber assets.
